(19) United States
(12) Patent Application Publication
(10) Pub. No.: US 2025/0016293 A1
(43) Pub. Date: Jan. 9, 2025

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventor: Toshihiro OOGUNI, Saitama-shi (JP)

(73) Assignee: FUJIFILM Corporation, Tokyo (JP)

(21) Appl. No.: 18/894,836

(22) Filed: Sep. 24, 2024

Related U.S. Application Data
(63) Continuation of application No. PCT/JP2023/008095, filed on Mar. 3, 2023.

(30) Foreign Application Priority Data
Mar. 25, 2022 (JP) 2022-049515

(51) Int. Cl. H04N 9/31

(52) U.S. Cl. CPC H04N 9/3147; H04N 9/3185; H04N 9/3188

(57) ABSTRACT

An information processing apparatus includes a processor configured to: acquire first image data representing a first image by an imaging apparatus, first virtual projection surface data about a first virtual projection surface, first virtual projection apparatus data about a first virtual projection apparatus corresponding to the first virtual projection surface, and second virtual projection apparatus data about a second virtual projection apparatus; generate second image data representing a second image in which the first virtual projection surface, one of the first virtual projection apparatus or an installable range of the first virtual projection apparatus, and one of the second virtual projection apparatus or an installable range of the second virtual projection apparatus are displayed on the first image based on the first virtual projection surface data, the first virtual projection apparatus data, and the second virtual projection apparatus data; and output the second image data to an output destination.

### CROSS REFERENCE TO RELATED APPLICATION

This is a continuation of International Application No. PCT/JP2023/008095 filed on Mar. 3, 2023, and claims priority from Japanese Patent Application No. 2022-049515 filed on Mar. 25, 2022, the entire disclosures of which are incorporated herein by reference.

### BACKGROUND OF THE INVENTION

### 1. Field of the Invention

The present invention relates to an information processing apparatus, an information processing method, and a computer readable medium storing an information processing program.

### 2. Description of the Related Art

JP2018-005115A discloses a projection image adjustment system that aims to facilitate the installation and adjustment of a projection type display device. JP2020-036120A discloses a projection apparatus that aims to reduce the time and effort required to install a projection apparatus for a video and project the video. JP2019-071567A discloses an information processing apparatus that assists in the installation of a projector, which aims to determine installation conditions for installing a drawing object and a projector that projects a projection image related to the drawing object based on projection image data.

### SUMMARY OF THE INVENTION

One embodiment according to the technology of the present disclosure provides an information processing apparatus, an information processing method, and a computer readable medium storing an information processing program capable of improving a convenience for a user in selecting a model of a projection apparatus to be installed.

According to one aspect of the present invention, there is provided an information processing apparatus comprising a processor, in which the processor is configured to: acquire first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus; generate second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and output the second image data to an output destination.

According to another aspect of the present invention, there is provided an information processing method performed by a processor of an information processing apparatus, the method comprising: acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus; generating second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and outputting the second image data to an output destination.

According to still another aspect of the present invention, there is provided an information processing program, stored in a computer readable medium, for causing a processor of an information processing apparatus to execute a process comprising: acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus; generating second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and outputting the second image data to an output destination.

According to the aspects of the present invention, it is possible to provide an information processing apparatus, an information processing method, and a computer readable medium storing an information processing program capable of improving a convenience for a user in selecting a model of a projection apparatus to be installed.

### BRIEF DESCRIPTION OF THE DRAWINGS

FIG. 1 is a schematic diagram showing an example of a projection apparatus 10 that is a target for installation support by an information processing apparatus according to an embodiment.

FIG. 2 is a schematic diagram showing an example of an internal configuration of a projection portion 1 shown in FIG. 1.

FIG. 3 is a schematic diagram showing an external configuration of the projection apparatus 10.

FIG. 4 is a schematic cross-sectional view of an optical unit 106 of the projection apparatus 10 shown in FIG. 3.

FIG. 5 is a diagram showing an example of an information processing apparatus 50 according to the embodiment.

FIG. 6 is a diagram showing an example of a hardware configuration of the information processing apparatus 50 according to the embodiment.

FIG. 7 is a flowchart showing an example of processing of the information processing apparatus 50 in a screen priority mode.

FIG. 8 is an example (part 1) of an image displayed by the information processing apparatus 50 in the processing shown in FIG. 7.

FIG. 9 is an example (part 2) of an image displayed by the information processing apparatus 50 in the processing shown in FIG. 7.

FIG. 10 is an example (part 3) of an image displayed by the information processing apparatus 50 in the processing shown in FIG. 7.

FIG. 11 is an example (part 4) of an image displayed by the information processing apparatus 50 in the processing shown in FIG. 7.

FIG. 12 is an example (part 5) of an image displayed by the information processing apparatus 50 in the processing shown in FIG. 7.

FIG. 13 is an example (part 6) of an image displayed by the information processing apparatus 50 in the processing shown in FIG. 7.

FIG. 14 is a flowchart showing an example of processing of the information processing apparatus 50 in a projector priority first mode.

FIG. 15 is an example (part 1) of an image displayed by the information processing apparatus 50 in the processing shown in FIG. 14.

FIG. 16 is an example (part 2) of an image displayed by the information processing apparatus 50 in the processing shown in FIG. 14.

FIG. 17 is an example (part 3) of an image displayed by the information processing apparatus 50 in the processing shown in FIG. 14.

FIG. 18 is an example (part 4) of an image displayed by the information processing apparatus 50 in the processing shown in FIG. 14.

FIG. 19 is an example (part 5) of an image displayed by the information processing apparatus 50 in the processing shown in FIG. 14.

FIG. 20 is a flowchart (part 1) showing an example of processing of the information processing apparatus 50 in a projector priority second mode.

FIG. 21 is a flowchart (part 2) showing an example of processing of the information processing apparatus 50 in the projector priority second mode.

FIG. 22 is an example (part 1) of an image displayed by the information processing apparatus 50 in the processing shown in FIGS. 20 and 21.

FIG. 23 is an example (part 2) of an image displayed by the information processing apparatus 50 in the processing shown in FIGS. 20 and 21.

FIG. 24 is an example (part 3) of an image displayed by the information processing apparatus 50 in the processing shown in FIGS. 20 and 21.

FIG. 25 is an example (part 4) of an image displayed by the information processing apparatus 50 in the processing shown in FIGS. 20 and 21.

FIG. 26 is an example (part 5) of an image displayed by the information processing apparatus 50 in the processing shown in FIGS. 20 and 21.

FIG. 27 is a flowchart showing an example of processing of the information processing apparatus 50 in a projector priority third mode.

FIG. 28 is a flowchart showing an example of the calculation in Step S277 in FIG. 27.

FIG. 29 is an example of an image displayed by the information processing apparatus 50 in the processing shown in FIG. 27 in the example of FIG. 28.

FIG. 30 is a flowchart showing another example of the calculation in Step S277 in FIG. 27.

FIG. 31 is an example (part 1) of an image displayed by the information processing apparatus 50 in the processing shown in FIG. 27 in the example of FIG. 30.

FIG. 32 is an example (part 2) of an image displayed by the information processing apparatus 50 in the processing shown in FIG. 27 in the example of FIG. 30.

FIG. 33 is a flowchart showing an example of processing of the information processing apparatus 50 in a model search mode.

FIG. 34 is an example (part 1) of an image displayed by the information processing apparatus 50 in the processing shown in FIG. 33.

FIG. 35 is an example (part 2) of an image displayed by the information processing apparatus 50 in the processing shown in FIG. 33.

FIG. 36 is an example (part 3) of an image displayed by the information processing apparatus 50 in the processing shown in FIG. 33.

FIG. 37 is an example (part 4) of an image displayed by the information processing apparatus 50 in the processing shown in FIG. 33.

FIG. 38 is an example (part 5) of an image displayed by the information processing apparatus 50 in the processing shown in FIG. 33.

### DESCRIPTION OF THE PREFERRED EMBODIMENTS

Hereinafter, an example of an embodiment of the present invention will be described with reference to the drawings.

### Example of Projection Apparatus 10 That Is Target for Installation Support by Information Processing Apparatus According to Embodiment

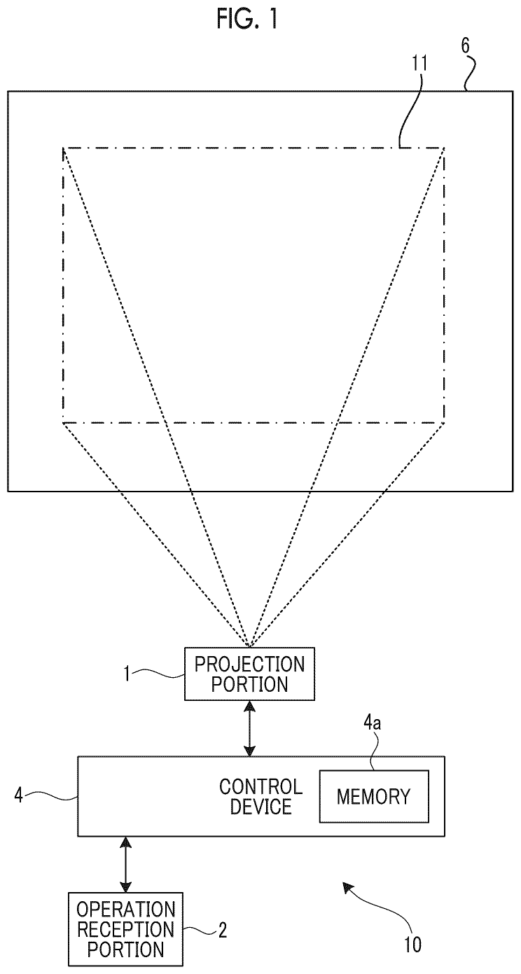

FIG. 1 is a schematic diagram showing an example of a projection apparatus 10 that is a target for installation support by an information processing apparatus according to an embodiment.

The information processing apparatus according to the embodiment can be used, for example, to support disposition of the projection apparatus 10. The projection apparatus 10 comprises a projection portion 1, a control device 4, and an operation reception portion 2. The projection portion 1 is composed of, for example, a liquid crystal projector or a projector using liquid crystal on silicon (LCOS). In the following description, it is assumed that the projection portion 1 is a liquid crystal projector.

The control device 4 is a control device that controls projection performed by the projection apparatus 10. The control device 4 is a device including a control unit composed of various processors, a communication interface (not shown) for communicating with each portion, and a memory 4a such as a hard disk, a solid-state drive (SSD), or a read-only memory (ROM) and integrally controls the projection portion 1.

Examples of the various processors of the control unit of the control device 4 include a central processing unit (CPU) which is a general-purpose processor that executes a program to perform various functions, a programmable logic device (PLD) which is a processor capable of changing a circuit configuration after manufacture such as a field-programmable gate array (FPGA), a dedicated electrical circuit which is a processor having a circuit configuration exclusively designed to execute specific processing such as an application-specific integrated circuit (ASIC), or the like.

More specifically, a structure of these various processors is an electrical circuit in which circuit elements such as semiconductor elements are combined. The control unit of the control device 4 may be configured with one of the various processors or may be configured with a combination of two or more processors of the same type or different types (for example, a combination of a plurality of FPGAs or a combination of a CPU and an FPGA).

The operation reception portion 2 detects an instruction from a user by receiving various operations from the user. The operation reception portion 2 may be a button, a key, a joystick, or the like provided in the control device 4 or may be a reception portion or the like that receives a signal from a remote controller for remotely operating the control device 4.

A projection object 6 is an object such as a screen or a wall having a projection surface on which a projection image is displayed by the projection portion 1. In the example shown in FIG. 1, the projection surface of the projection object 6 is a rectangular plane. It is assumed that upper, lower, left, and right sides of the projection object 6 in FIG. 1 are upper, lower, left, and right sides of the actual projection object 6.

A projection range 11 shown by a dot-dashed line is a region irradiated with projection light by the projection portion 1 in the projection object 6. In the example shown in FIG. 1, the projection range 11 is rectangular. The projection range 11 is a part or the entirety of a projectable range in which the projection can be performed by the projection portion 1.

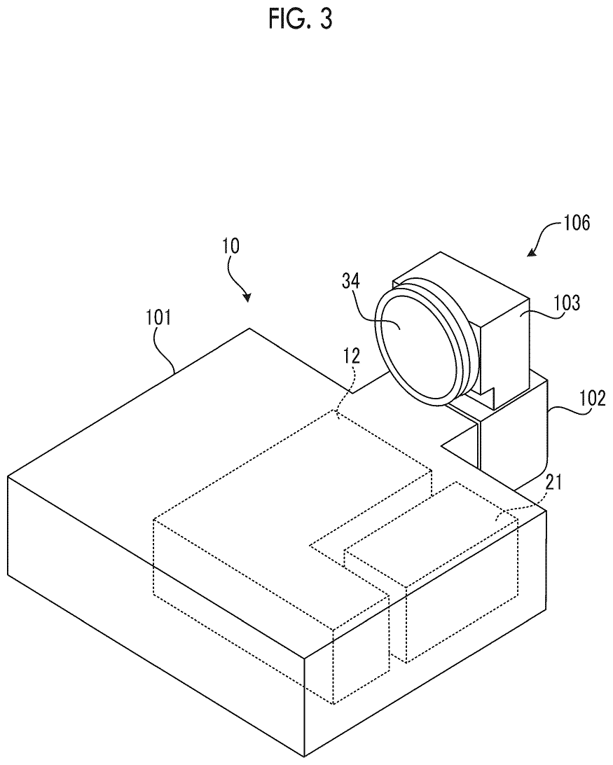

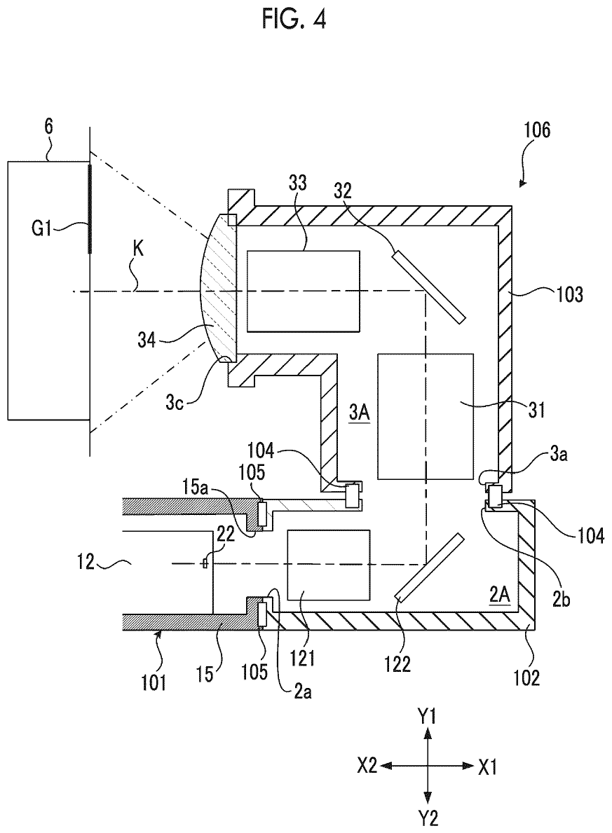

The projection portion 1, the control device 4, and the operation reception portion 2 are implemented by, for example, a single device (for example, see FIGS. 3 and 4). Alternatively, the projection portion 1, the control device 4, and the operation reception portion 2 may be separate devices that cooperate by communicating with each other.

### <Internal Configuration of Projection Portion 1 Shown in FIG. 1>

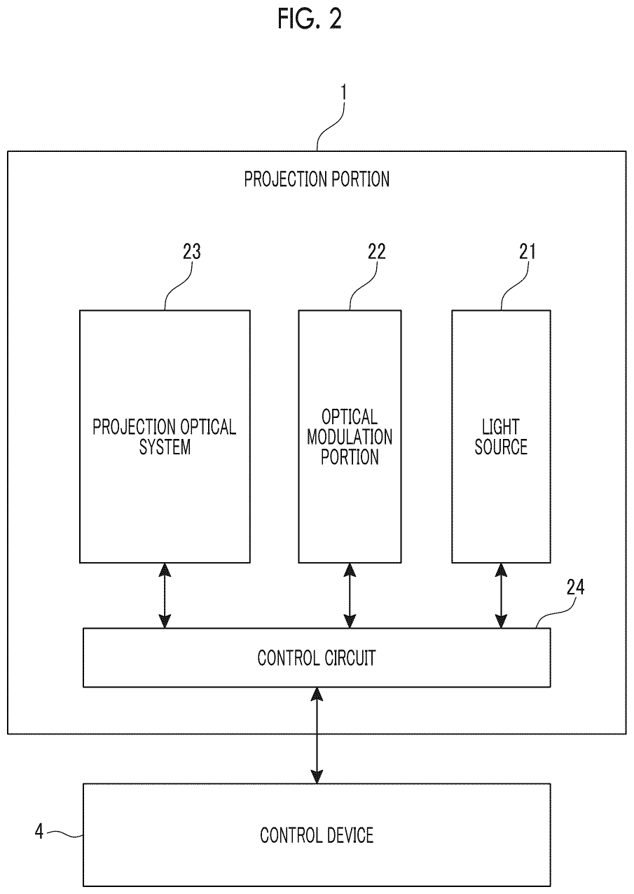

FIG. 2 is a schematic diagram showing an example of an internal configuration of the projection portion 1 shown in FIG. 1.

As shown in FIG. 2, the projection portion 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, each color light beam which is emitted from the light source 21 and is separated into three colors of red, blue, and green by a color separation mechanism (not shown). Filters of red, blue, and green may be mounted in each of the three liquid crystal panels, and each color image may be emitted by modulating the white light emitted from the light source 21 in each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected onto the projection object 6.

In the projection object 6, a region irradiated with the light transmitted through the entire range of the optical modulation portion 22 is the projectable range in which the projection can be performed by the projection portion 1. Within this projectable range, a region irradiated with the light actually transmitted through the optical modulation portion 22 is the projection range 11. For example, in the projectable range, a size, a position, and a shape of the projection range 11 are changed by controlling a size, a position, and a shape of a region through which the light is transmitted in the optical modulation portion 22.

The control circuit 24 controls the light source 21, the optical modulation portion 22, and the projection optical system 23 based on the display data input from the control device 4, thereby projecting an image based on this display data onto the projection object 6. The display data input to the control circuit 24 is composed of three pieces of data including red display data, blue display data, and green display data.

In addition, the control circuit 24 changes the projection optical system 23 based on an instruction input from the control device 4, thereby enlarging or reducing the projection range 11 (see FIG. 1) of the projection portion 1. In addition, the control device 4 may move the projection range 11 of the projection portion 1 by changing the projection optical system 23 based on the operation received by the operation reception portion 2 from the user.

The projection apparatus 10 also comprises a shift mechanism that mechanically or optically moves the projection range 11 while maintaining an image circle of the projection optical system 23. The image circle of the projection optical system 23 is a region where the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting or an electronic shift mechanism that performs electronic shifting.

The optical system shift mechanism is, for example, a mechanism (for example, see FIGS. 3 and 4) that moves the projection optical system 23 in a direction perpendicular to an optical axis or a mechanism that moves the optical modulation portion 22 in the direction perpendicular to the optical axis instead of moving the projection optical system 23. Furthermore, the optical system shift mechanism may perform the movement of the projection optical system 23 and the movement of the optical modulation portion 22 in combination with each other.

The electronic shift mechanism is a mechanism that performs pseudo shifting of the projection range 11 by changing a range through which the light is transmitted in the optical modulation portion 22.

The projection apparatus 10 may also comprise a projection direction changing mechanism that moves the image circle of the projection optical system 23 and the projection range 11. The projection direction changing mechanism is a mechanism that changes a projection direction of the projection portion 1 by changing the orientation of the projection portion 1 through mechanical rotation (for example, see FIGS. 3 and 4).

### <Mechanical Configuration of Projection Apparatus 10>

FIG. 3 is a schematic diagram showing an external configuration of the projection apparatus 10. FIG. 4 is a schematic cross-sectional view of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception portion 2, the control device 4, and the light source 21, the optical modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (see FIG. 4) in which an opening 15a (see FIG. 4) for passing light is formed in a part connected to the optical unit 106.

As shown in FIG. 3, the light source 21 and an optical modulation unit 12 including the optical modulation portion 22 (see FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected onto the projection object 6 as a projection target object. Accordingly, an image G1 is visible from an observer.

As shown in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional outer shape, in which an opening 2a and an opening 2b are formed in surfaces perpendicular to each other. The first member 102 is supported by the body part 101 in a state in which the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

The incidence direction of the light incident into the hollow portion 2A from the body part 101 will be referred to as a direction X1, the direction opposite to the direction X1 will be referred to as a direction X2, and the direction X1 and the direction X2 will be collectively referred to as a direction X. In FIG. 4, the direction from the front to the back of the page and the opposite direction thereto will be referred to as a direction Z. In the direction Z, the direction from the front to the back of the page will be referred to as a direction Z1, and the direction from the back to the front of the page will be referred to as a direction Z2.

In addition, the direction perpendicular to the direction X and to the direction Z will be referred to as a direction Y. In the direction Y, the upward direction in FIG. 4 will be referred to as a direction Y1, and the downward direction in FIG. 4 will be referred to as a direction Y2. In the example in FIG. 4, the projection apparatus 10 is disposed such that the direction Y2 is the vertical direction.

The projection optical system 23 shown in FIG. 2 is composed of the first optical system 121, the reflective member 122, the second optical system 31, the reflective member 32, the third optical system 33, and the lens 34. An optical axis K of the projection optical system 23 is shown in FIG. 4. The first optical system 121, the reflective member 122, the second optical system 31, the reflective member 32, the third optical system 33, and the lens 34 are disposed in this order from the optical modulation portion 22 side along the optical axis K.

The first optical system 121 includes at least one lens and guides the light that is incident on the first member 102 from the body part 101 and travels in the direction X1 to the reflective member 122.

The reflective member 122 reflects the light incident from the first optical system 121 in the direction Y1. The reflective member 122 is composed of, for example, a mirror. In the first member 102, the opening 2b is formed on the optical path of light reflected by the reflective member 122, and the reflected light travels to the hollow portion 3A of the second member 103 by passing through the opening 2b.

The second member 103 is a member having an approximately T-shaped cross-sectional outer shape, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional outer shape and are not limited to the above.

The second optical system 31 includes at least one lens and guides the light incident from the first member 102 to the reflective member 32.

The reflective member 32 reflects the light incident from the second optical system 31 in the direction X2 and guides the light to the third optical system 33. The reflective member 32 is composed of, for example, a mirror.

The third optical system 33 includes at least one lens and guides the light reflected by the reflective member 32 to the lens 34.

The lens 34 is disposed at an end part of the second member 103 on the direction X2 side in a form of closing the opening 3c formed at this end part. The lens 34 projects the light incident from the third optical system 33 onto the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 4 as long as the projection direction changing mechanism 104 can rotate the optical system. Furthermore, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be able to change a position of the first member 102 in the direction Y with respect to the body part 101. The shift mechanism 105 may manually move the first member 102 or electrically move the first member 102.

FIG. 4 shows a state in which the first member 102 is moved as far as possible to the direction Y1 side by the shift mechanism 105. By moving the first member 102 in the direction Y2 by the shift mechanism 105 from the state shown in FIG. 4, the relative position between the center of the image (in other words, the center of the display surface) formed by the optical modulation portion 22 and the optical axis K changes, and the image G1 projected onto the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected onto the projection object 6 can be moved in the direction Y2.

### <Information Processing Apparatus 50 According to Embodiment>

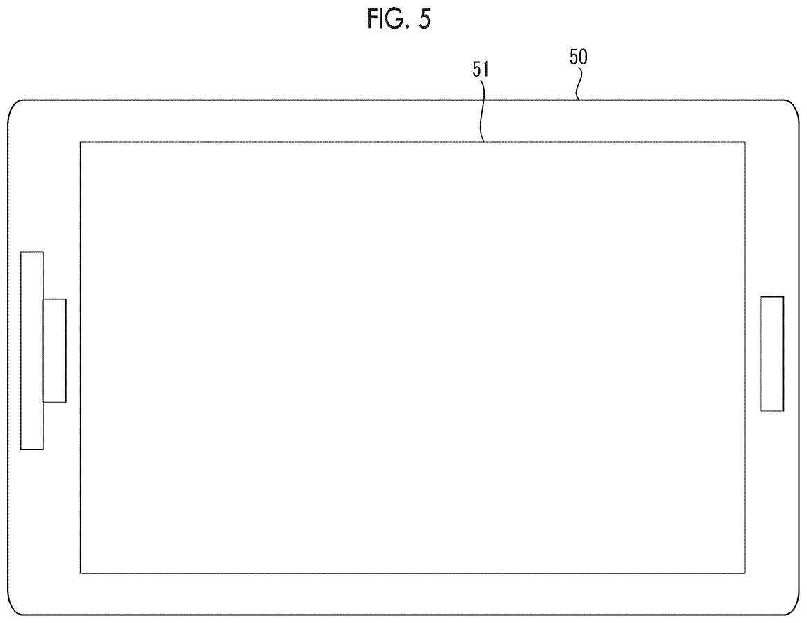

FIG. 5 is a diagram showing an example of the information processing apparatus 50 according to the embodiment. The information processing apparatus 50 according to the embodiment is a tablet terminal having a touch panel 51. The touch panel 51 is a display that allows a touch operation. For example, a user of the information processing apparatus 50 brings the information processing apparatus 50 into a space (for example, a room) in which the projection apparatus 10 is installed and performs the projection. The information processing apparatus 50 displays, on the touch panel 51, an installation support image for supporting installation of the projection apparatus 10 in the space.

Specifically, the information processing apparatus 50 displays a second image in which a first virtual projection surface, which is a virtual projection surface, a first virtual projection apparatus which is a first virtual projection apparatus or a first installable range of the first virtual projection apparatus, and a second virtual projection apparatus which is a second virtual projection apparatus or a second installable range of the second virtual projection apparatus, are superimposed on a first image obtained by imaging the space in which the projection apparatus 10 is installed and performs the projection, thereby considering the installation of the projection apparatus 10 while comparing the first virtual projection apparatus with the second virtual projection apparatus. The first virtual projection apparatus and the second virtual projection apparatus virtually represent candidates for the projection apparatus 10. A user can designate different models of projection apparatuses as the first virtual projection apparatus and the second virtual projection apparatus. Furthermore, the user may be able to designate, as the first virtual projection apparatus and the second virtual projection apparatus, projection apparatuses made by different manufacturers.

### <Hardware Configuration of Information Processing Apparatus 50>

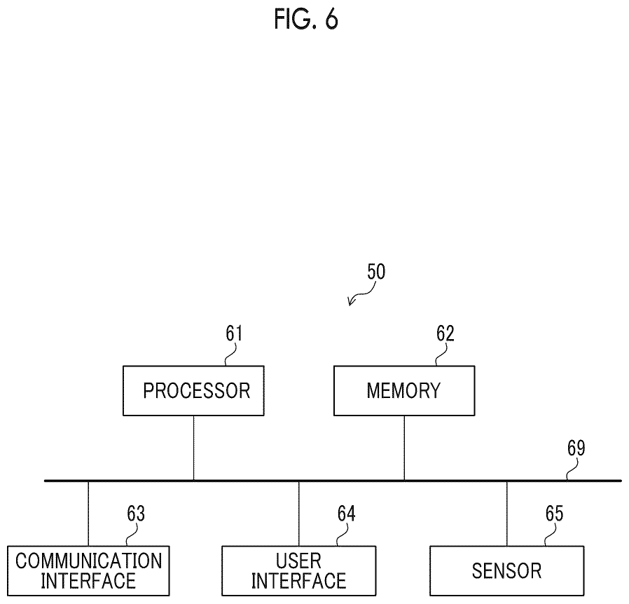

FIG. 6 is a diagram showing an example of a hardware configuration of the information processing apparatus 50 according to the embodiment. For example, as shown in FIG. 6, the information processing apparatus 50 shown in FIG. 5 comprises a processor 61, a memory 62, a communication interface 63, a user interface 64, and a sensor 65. The processor 61, the memory 62, the communication interface 63, the user interface 64, and the sensor 65 are connected by, for example, a bus 69.

The processor 61 is a circuit that performs signal processing, and is, for example, a CPU that controls the entire information processing apparatus 50. The processor 61 may be implemented by other digital circuits such as an FPGA and a digital signal processor (DSP). The processor 61 may also be implemented by combining a plurality of digital circuits.

For example, the memory 62 includes a main memory and an auxiliary memory. For example, the main memory is a random-access memory (RAM). The main memory is used as a work area of the processor 61.

The auxiliary memory is, for example, a non-volatile memory such as a magnetic disk or a flash memory. The auxiliary memory stores various programs for operating the information processing apparatus 50. The programs stored in the auxiliary memory are loaded into the main memory and executed by the processor 61.

In addition, the auxiliary memory may include a portable memory that can be detached from the information processing apparatus 50. Examples of the portable memory include a memory card such as a universal serial bus (USB) flash drive or a secure digital (SD) memory card, and an external hard disk drive.

The communication interface 63 is a communication interface for communicating with apparatuses outside the information processing apparatus 50. The communication interface 63 includes at least any of a wired communication interface for performing wired communication or a wireless communication interface for performing wireless communication. The communication interface 63 is controlled by the processor 61.

The user interface 64 includes, for example, an input device that receives an operation input from the user, and an output device that outputs information to the user. The input device can be implemented by, for example, a key (for example, a keyboard) or a remote controller. The output device can be implemented by, for example, a display or a speaker. In the information processing apparatus 50 shown in FIG. 5, the input device and the output device are implemented by the touch panel 51. The user interface 64 is controlled by the processor 61.

The sensor 65 includes an imaging apparatus that includes an imaging optical system and an imaging element and that can perform imaging, a space recognition sensor that can three-dimensionally recognize a space around the information processing apparatus 50, and the like. For example, the imaging apparatus includes an imaging apparatus provided on a rear surface of the information processing apparatus 50 illustrated in FIG. 5.

The space recognition sensor is, as an example, a light detection and ranging (LiDAR) sensor of performing irradiation with laser light, measuring a time taken until the laser light of irradiation hits an object and reflects back, and measuring a distance and a direction to the object. However, the space recognition sensor is not limited thereto and can be various sensors such as a radar that emits radio waves, and an ultrasonic sensor that emits ultrasound waves.

The information processing apparatus 50 executes at least any of the processes of, for example, the following screen priority mode, projector priority first mode, projector priority second mode, projector priority third mode, and model search mode.

### (Screen Priority Mode)

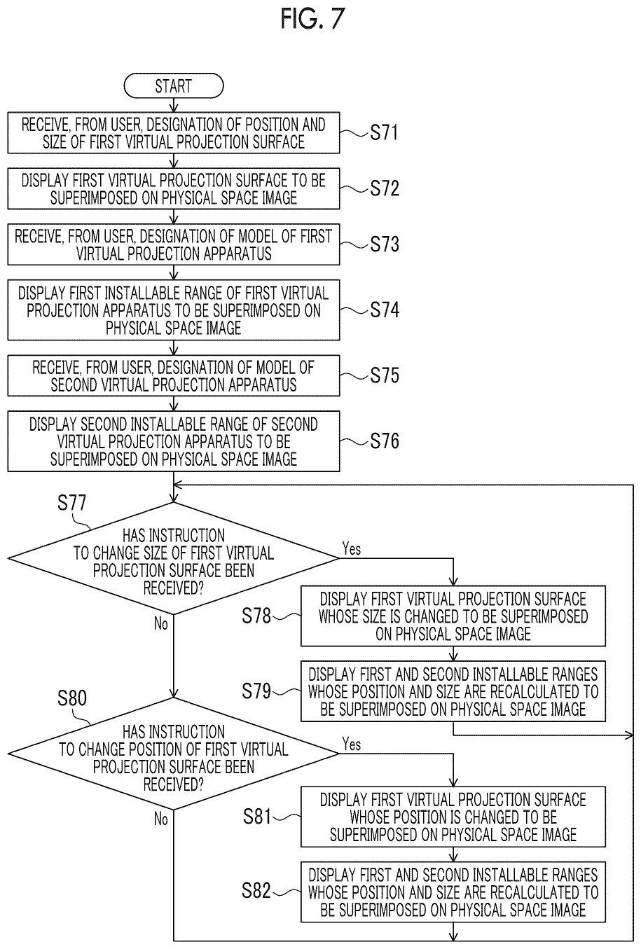

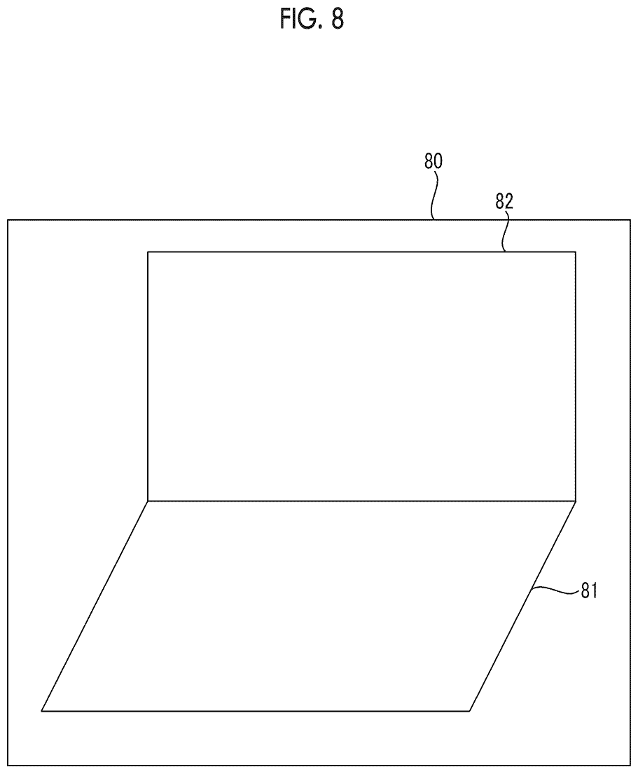

FIG. 7 is a flowchart showing an example of processing of the information processing apparatus 50 in the screen priority mode. FIGS. 8 to 13 are examples of images displayed by the information processing apparatus 50 in the processing shown in FIG. 7. For example, at the start of the processing shown in FIG. 7, the information processing apparatus 50 displays a physical space image 80 shown in FIG. 8. The physical space image 80 is, for example, a through-image (live view image) that shows an image captured by an imaging apparatus provided as the sensor 65 of the information processing apparatus 50 in real time. The physical space image 80 is an example of a first image according to the embodiment of the present invention.

Furthermore, the information processing apparatus 50 recognizes the physical space shown in the physical space image 80 three-dimensionally. For this space recognition, for example, a space recognition sensor included in the sensor 65 of the information processing apparatus 50 is used. A floor 81 and a wall 82 are present in the physical space shown in the physical space image 80. Here, it is assumed that the projection apparatus 10 is installed on the floor 81 and performs projection onto the wall 82.

First, the information processing apparatus 50 receives, from the user, designation of the position and the size of the first virtual projection surface (Step S71). The first virtual projection surface virtually shows the above-mentioned projection range 11, for example. The position of the first virtual projection surface is, for example, the center position (position of the projection center) of the first virtual projection surface. For example, the position of the first virtual projection surface is designated as two-dimensional coordinates of the physical space image 80 by the user giving an instruction to set one point in the physical space image 80 as the center position of the first virtual projection surface. The information processing apparatus 50 receives the designated two-dimensional coordinates as a three-dimensional position of the first virtual projection surface by converting the designated two-dimensional coordinates into three-dimensional coordinates based on the recognition result of the physical space shown in the physical space image 80. The size of the first virtual projection surface is designated using an actual distance in the physical space, for example, the length of the diagonal line=x[inches].

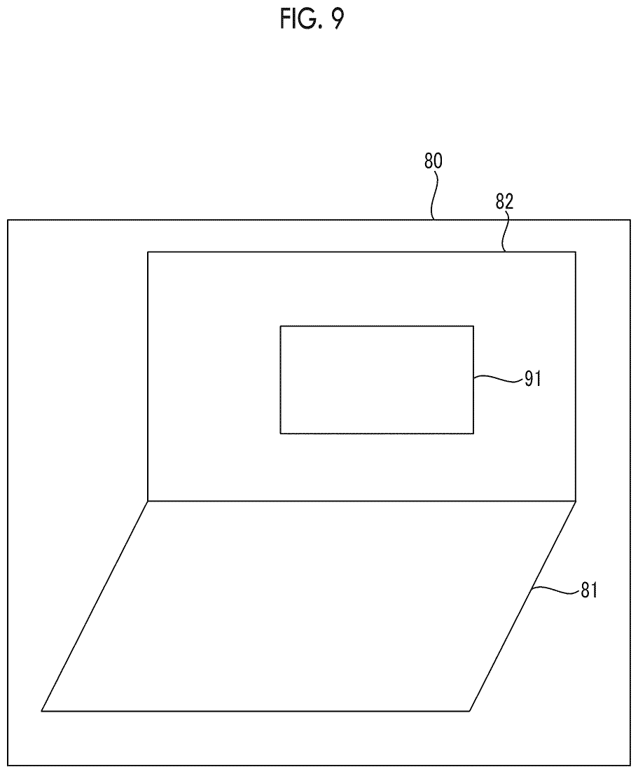

Next, the information processing apparatus 50 displays the first virtual projection surface to be superimposed on the physical space image 80 based on the designation received in Step S71 (Step S72). Specifically, the information processing apparatus 50 calculates a three-dimensional region of the first virtual projection surface in the physical space shown in the physical space image 80, converts the three-dimensional region into a two-dimensional region corresponding to the physical space image 80 based on the recognition result of the physical space shown in the physical space image 80, and superimposes an image showing the converted region on the physical space image 80 as the first virtual projection surface. For example, as shown in FIG. 9, the information processing apparatus 50 displays an image obtained by superimposing a first virtual projection surface 91 on the physical space image 80.

Next, the information processing apparatus 50 receives, from the user, designation of the model of the first virtual projection apparatus from among a plurality of options of the model of the projection apparatus 10 (Step S73). Next, the information processing apparatus 50 calculates, for example, the position and size of the first installable range represented by a polyhedron based on the current position and size of the first virtual projection surface 91 and a projection ratio and a lens shift amount that can be set for the model that has been designated as the model of the first virtual projection apparatus in Step S73, and displays the first installable range whose position and size are calculated to be superimposed on the physical space image 80 (Step S74).

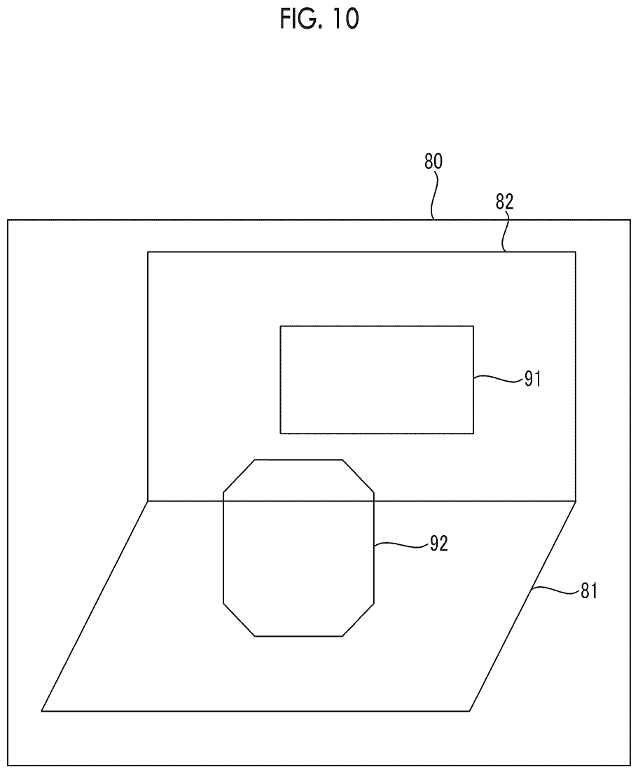

Specifically, the information processing apparatus 50 calculates a three-dimensional region of the first installable range in the physical space shown in the physical space image 80, converts the three-dimensional region into a two-dimensional region corresponding to the physical space image 80 based on the recognition result of the physical space shown in the physical space image 80, and superimposes an image showing the converted region on the physical space image 80 as the first installable range. For example, as shown in FIG. 10, the information processing apparatus 50 displays an image obtained by superimposing the first virtual projection surface 91 and a first installable range 92 on the physical space image 80.

Next, the information processing apparatus 50 receives, from the user, designation of the model of the second virtual projection apparatus from among a plurality of options of the model of the projection apparatus 10 (Step S75). Next, the information processing apparatus 50 calculates, for example, the position and the size of the second installable range represented by a polyhedron based on the current position and size of the first virtual projection surface 91 and a projection ratio and a lens shift amount that can be set for the model that has been designated as the model of the second virtual projection apparatus in Step S75, and displays the second installable range whose position and size are calculated to be superimposed on the physical space image 80 (Step S76).

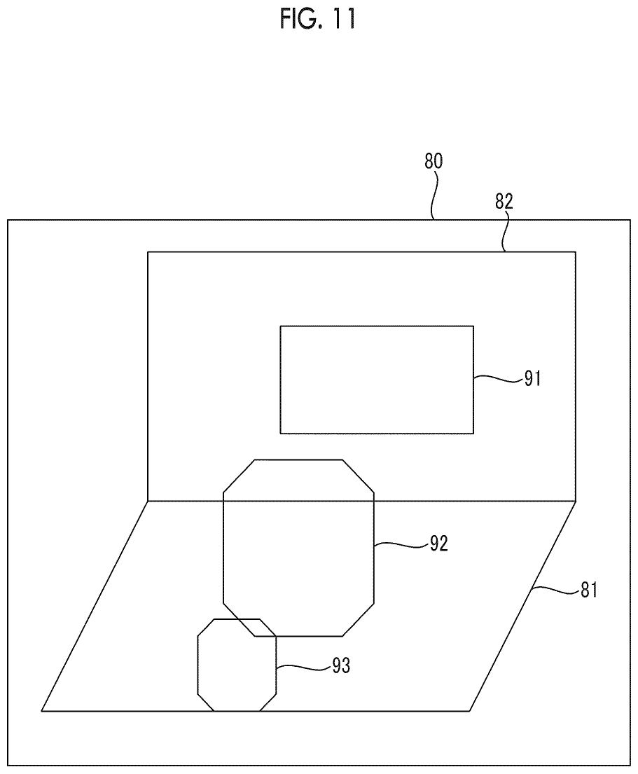

Specifically, the information processing apparatus 50 calculates a three-dimensional region of the second installable range in the physical space shown in the physical space image 80, converts the three-dimensional region into a two-dimensional region corresponding to the physical space image 80 based on the recognition result of the physical space shown in the physical space image 80, and superimposes an image showing the converted region on the physical space image 80 as the second installable range. For example, as shown in FIG. 11, the information processing apparatus 50 displays an image obtained by superimposing the first virtual projection surface 91, the first installable range 92, and a second installable range 93 on the physical space image 80.

Accordingly, the user can visually compare the installable ranges (for example, the first installable range 92 and the second installable range 93) of the projection apparatuses (for example, the first virtual projection apparatus and the second virtual projection apparatus) having different setting ranges of the parameters such as the projection ratio and the lens shift amount to a desired projection surface (for example, the first virtual projection surface 91), making it easier to select an appropriate model of the projection apparatus.

Next, the information processing apparatus 50 determines whether or not an instruction to change the size of the first virtual projection surface 91 has been received from the user (Step S77). In a case in which an instruction to change the size of the first virtual projection surface 91 has been received (Step S77: Yes), the information processing apparatus 50 changes the size of the first virtual projection surface 91 and displays the first virtual projection surface 91 whose size is changed to be superimposed on the physical space image 80 (Step S78).

In addition, the information processing apparatus 50 recalculates the position and the size of the first installable range 92 based on the current position and size of the first virtual projection surface 91 and the projection ratio and the lens shift amount that can be set for the model that has been designated as the model of the first virtual projection apparatus in Step S73. In addition, the information processing apparatus 50 recalculates the position and the size of the second installable range 93 based on the current position and size of the first virtual projection surface 91 and the projection ratio and the lens shift amount that can be set for the model that has been designated as the model of the second virtual projection apparatus in Step S75. Then, the information processing apparatus 50 displays the first installable range 92 and the second installable range 93 whose position and size are recalculated to be superimposed on the physical space image 80 (Step S79), and returns to Step S77.

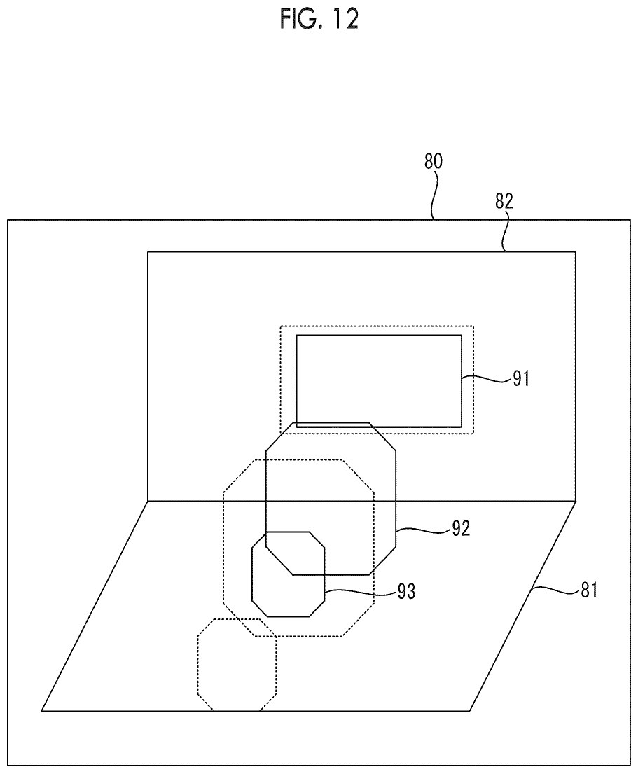

Accordingly, the user can visually ascertain a change in the position and the size of the installable range of the first installable range 92 and the second installable range 93 in response to a change in the size of the first virtual projection surface 91, making it easier to select an appropriate model. For example, it is assumed that a change instruction is given to change the size of the first virtual projection surface 91 from x [inches] to y [inches] (x>y). In this case, for example, as shown in FIG. 12, in conjunction with the reduction of the first virtual projection surface 91, the first installable range 92 and the second installable range 93 are reduced, and the distance between the first installable range 92 and the second installable range 93 from the first virtual projection surface 91 is reduced.

In Step S77, in a case in which an instruction to change the size of the first virtual projection surface 91 has not been received (Step S77: No), the information processing apparatus 50 determines whether or not an instruction to change the position of the first virtual projection surface 91 has been received (Step S80). In a case in which an instruction to change the position of the first virtual projection surface 91 has been received (Step S80: Yes), the information processing apparatus 50 changes the position of the first virtual projection surface 91 and displays the first virtual projection surface 91 whose position is changed to be superimposed on the physical space image (Step S81).

In addition, similarly to Step S79, the information processing apparatus 50 recalculates the position and the size of each of the first installable range 92 and the second installable range 93, and displays the first installable range 92 and the second installable range 93 whose position and size are recalculated to be superimposed on the physical space image 80 (Step S82), and returns to Step S77.

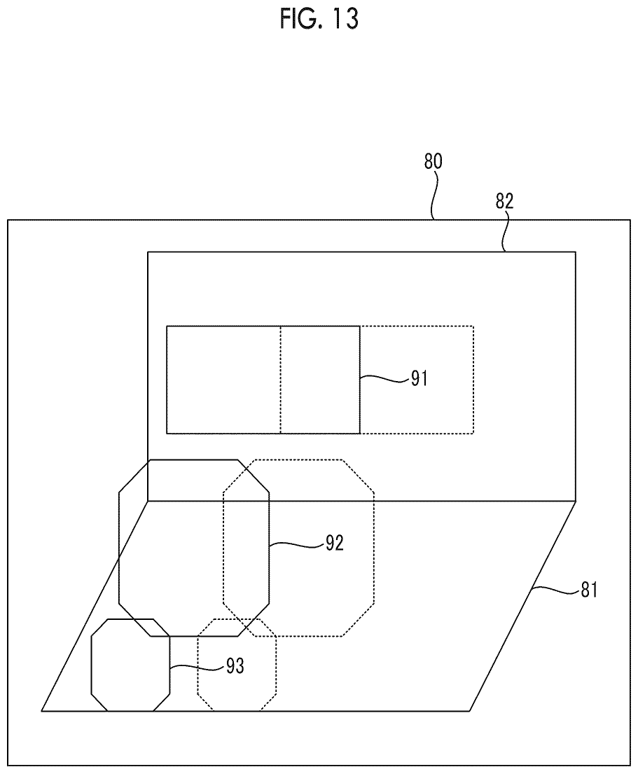

Accordingly, the user can visually ascertain a change in the position and the size of the installable range of the first installable range 92 and the second installable range 93 in response to a change in the position of the first virtual projection surface 91, making it easier to select an appropriate model. For example, it is assumed that a change instruction is given to move the position of the first virtual projection surface 91 in the left direction toward the first virtual projection surface 91. In this case, for example, as shown in FIG. 13, in conjunction with the movement of the first virtual projection surface 91 in the left direction, the first installable range 92 and the second installable range 93 are moved in the left direction.

In Step S80, in a case in which an instruction to change the position of the first virtual projection surface 91 has not been received (Step S80: No), the information processing apparatus 50 returns to Step S77.

In this way, in the screen priority mode, the information processing apparatus 50 displays a second image including the first virtual projection surface 91, the first installable range 92 of the first virtual projection apparatus, and the second installable range 93 of the second virtual projection apparatus. In addition, the information processing apparatus 50 sets the first installable range 92 of the first virtual projection apparatus and the second installable range 93 of the second virtual projection apparatus based on the position and the size of the first virtual projection surface 91. Moreover, the information processing apparatus 50 may set the first installable range 92 of the first virtual projection apparatus and the second installable range 93 of the second virtual projection apparatus based on any of the position and the size of the first virtual projection surface 91.

In addition, in the screen priority mode, in a case in which at least any of the position or the size of the first virtual projection surface 91 is changed, the information processing apparatus 50 resets (sets once again) the first installable range 92 of the first virtual projection apparatus and the second installable range 93 of the second virtual projection apparatus.

### (Projector Priority First Mode)

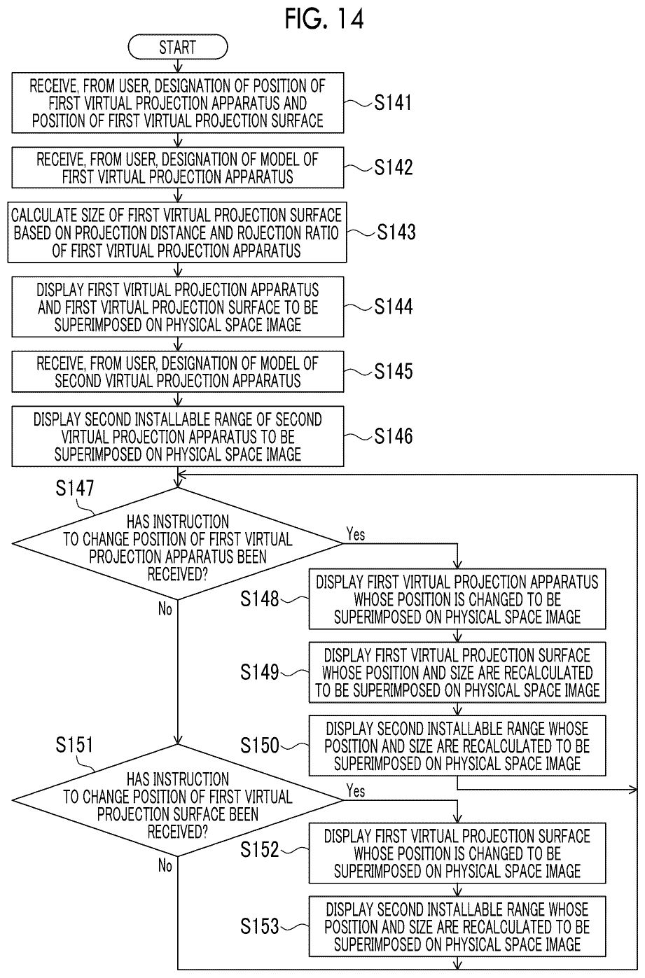

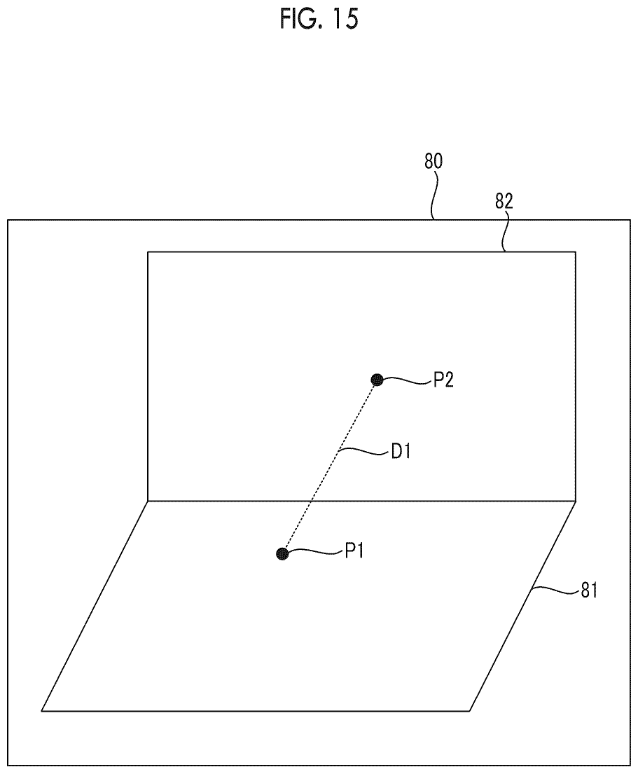

FIG. 14 is a flowchart showing an example of processing of the information processing apparatus 50 in the projector priority first mode. FIGS. 15 to 19 are examples of images displayed by the information processing apparatus 50 in the processing shown in FIG. 14. As in the case of the screen priority mode, the information processing apparatus 50 displays the physical space image 80 shown in FIG. 8 at the start of the processing shown in FIG. 14. Furthermore, the information processing apparatus 50 recognizes the physical space shown in the physical space image 80 three-dimensionally.

First, the information processing apparatus 50 receives, from the user, designation of the position of the first virtual projection apparatus and the position (position of the projection center) of the first virtual projection surface 91 (Step S141). The position of the first virtual projection apparatus is, for example, the position of the front lens of a projection lens of the first virtual projection apparatus. For example, the information processing apparatus 50 receives designation of a position P1 of the first virtual projection apparatus and a position P2 of the first virtual projection surface 91 shown in FIG. 15. The information processing apparatus 50 calculates a projection distance D1 that is a distance between the positions P1 and P2 based on the positions P1 and P2 that have been designated.

Next, the information processing apparatus 50 receives, from the user, designation of the model of the first virtual projection apparatus from among a plurality of options of the model of the projection apparatus 10 (Step S142). Next, the information processing apparatus 50 calculates the size of the first virtual projection surface 91 based on the projection distance D1 and the projection ratio corresponding to the model of the first virtual projection apparatus designated in Step S142 (Step S143).

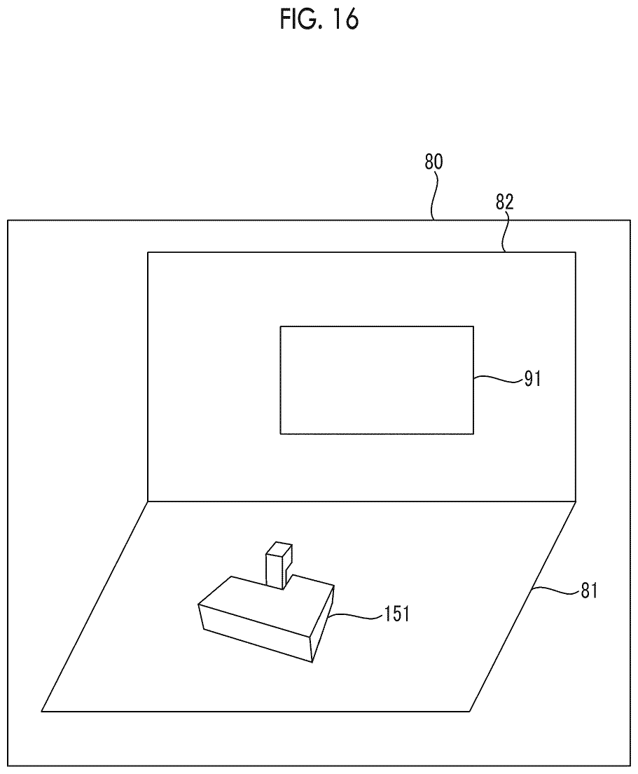

In addition, the information processing apparatus 50 displays a first virtual projection apparatus 151, which is a three-dimensional model of the first virtual projection apparatus designated in Step S142, and the first virtual projection surface 91 to be superimposed on the physical space image 80 (Step S144). For example, as shown in FIG. 16, the information processing apparatus 50 displays an image obtained by superimposing the first virtual projection apparatus 151 and the first virtual projection surface 91 on the physical space image 80.

The first virtual projection apparatus 151 is disposed such that the front lens of the projection lens of the first virtual projection apparatus 151 is at the position P1 shown in FIG. 15. The first virtual projection surface 91 is disposed such that the center position of the first virtual projection surface 91 is at the position P2 shown in FIG. 15. In addition, the size of the first virtual projection surface 91 is the size calculated in Step S143.

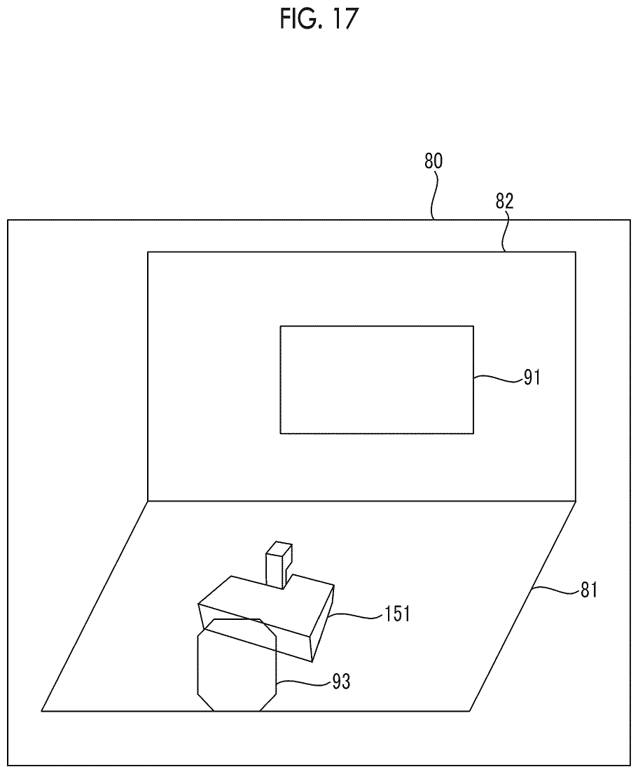

Next, the information processing apparatus 50 receives designation of the model of the second virtual projection apparatus from among a plurality of options of the model of the projection apparatus 10 (Step S145). Next, the information processing apparatus 50 calculates, for example, the position and the size of the second installable range 93 in which the second virtual projection apparatus can be installed based on the position and the size of the first virtual projection surface 91 and a projection ratio and a lens shift amount that can be set for the model that has been designated as the model of the second virtual projection apparatus in Step S145, and displays the second installable range 93 whose position and size are calculated to be superimposed on the physical space image 80 (Step S146). For example, as shown in FIG. 17, the information processing apparatus 50 displays an image obtained by superimposing the first virtual projection apparatus 151, the first virtual projection surface 91, and the second installable range 93 on the physical space image 80.

Accordingly, the user can visually ascertain the second installable range 93 of the second virtual projection apparatus as a comparison target for the first virtual projection apparatus 151 that is temporarily virtually disposed, making it easier to select an appropriate model.

Next, the information processing apparatus 50 determines whether or not an instruction to change the position of the first virtual projection apparatus 151 has been received from the user (Step S147). In a case in which an instruction to change the position of the first virtual projection apparatus 151 has been received (Step S147: Yes), the information processing apparatus 50 changes the position of the first virtual projection apparatus 151 and displays the first virtual projection apparatus 151 whose position is changed to be superimposed on the physical space image 80 (Step S148).

In addition, the information processing apparatus 50 recalculates the position and the size of the first virtual projection surface 91 based on the current position of the first virtual projection apparatus 151 and the projection ratio and the lens shift amount that can be set for the model that has been designated as the model of the first virtual projection apparatus in Step

S142. Then, the information processing apparatus 50 displays the first virtual projection surface 91 whose position and size are recalculated to be superimposed on the physical space image 80 (Step S149).

Next, the information processing apparatus 50 recalculates the position and the size of the second installable range 93 based on the recalculated position and size of the first virtual projection surface 91 and the projection ratio and the lens shift amount that can be set for the model that has been designated as the model of the second virtual projection apparatus in Step S145. Then, the information processing apparatus 50 displays the second installable range 93 whose position and size are recalculated to be superimposed on the physical space image 80 (Step S150), and returns to Step S147.

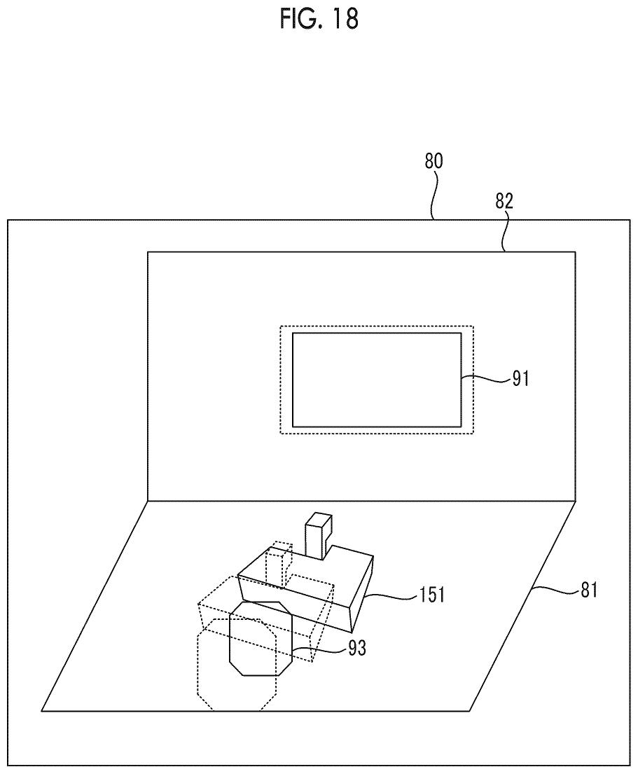

Accordingly, the user can visually ascertain changes in the position and the size of the second installable range 93 of the model (second virtual projection apparatus) as a comparison target in response to a change in the size of the first virtual projection surface 91, making it easier to select an appropriate model. For example, it is assumed that a change instruction is given to bring the first virtual projection apparatus 151 close to the first virtual projection surface 91. In this case, for example, as shown in FIG. 18, in conjunction with the movement of the first virtual projection apparatus 151 to the side of the first virtual projection surface 91, the first virtual projection surface 91 is reduced, the second installable range 93 is moved to the side of the first virtual projection surface 91, and the second installable range 93 is reduced.

In Step S147, in a case in which an instruction to change the position of the first virtual projection apparatus 151 has not been received (Step S147: No), the information processing apparatus 50 determines whether or not an instruction to change the position of the first virtual projection surface 91 has been received from the user (Step S151). In a case in which an instruction to change the position of the first virtual projection surface 91 has been received (Step S151: Yes), the information processing apparatus 50 changes the position of the first virtual projection surface 91 and displays the first virtual projection surface 91 whose position is changed to be superimposed on the physical space image 80 (Step S152).

Next, the information processing apparatus 50 recalculates the position and the size of the second installable range 93 based on the current position and size of the first virtual projection surface 91 and the projection ratio and the lens shift amount that can be set for the model that has been designated as the model of the second virtual projection apparatus in Step S145. Then, the information processing apparatus 50 displays the second installable range 93 whose position and size are recalculated to be superimposed on the physical space image 80 (Step S153), and returns to Step S147.

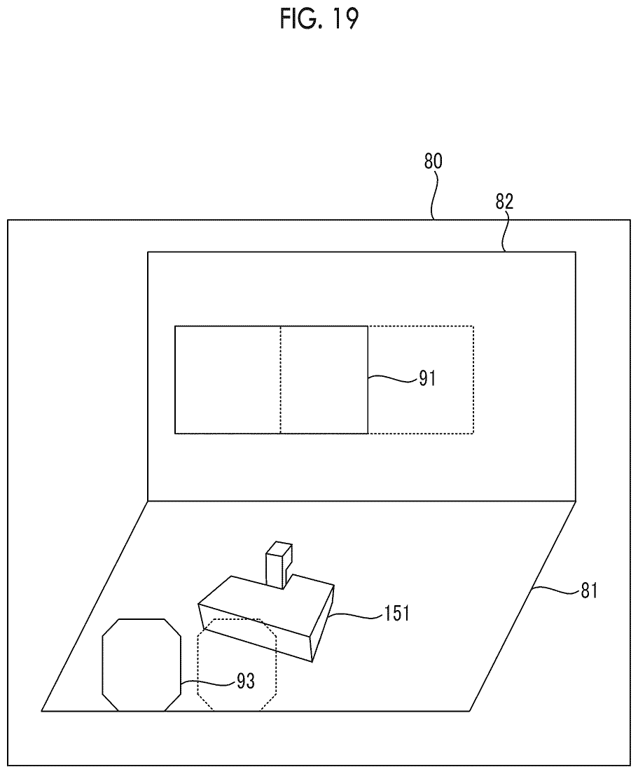

Accordingly, the user can visually ascertain a change in the position of the second installable range 93 of the model (second virtual projection apparatus) as a comparison target in response to a change in the position of the first virtual projection surface 91, making it easier to select an appropriate model. For example, it is assumed that a change instruction is given to move the position of the first virtual projection surface 91 in the left direction toward the first virtual projection surface 91. In this case, for example, as shown in FIG. 19, in conjunction with the movement of the first virtual projection surface 91 in the left direction, the second installable range 93 is moved in the left direction.

In Step S151, in a case in which an instruction to change the position of the first virtual projection surface 91 has not been received (Step S151: No), the information processing apparatus 50 returns to Step S147.

The information processing apparatus 50 may receive, from the user, an instruction to change the projection ratio of the first virtual projection apparatus 151 after Step S147. For example, in a case in which a change instruction to decrease the projection ratio of the first virtual projection apparatus 151 has been received, the information processing apparatus 50 reduces the first virtual projection surface 91 while maintaining the position of the first virtual projection apparatus 151. In this case, the information processing apparatus 50 moves the second installable range 93 toward the first virtual projection surface 91 and reduces the second installable range 93.

In this way, in the projector priority first mode, the information processing apparatus 50 displays a second image including the first virtual projection surface 91, the first virtual projection apparatus 151, and the second installable range 93 of the second virtual projection apparatus. In addition, the information processing apparatus 50 sets at least any of the position or the size of the first virtual projection surface 91 based on the position of the first virtual projection apparatus 151, and sets the second installable range 93 of the second virtual projection apparatus based on at least any of the set position or the set size of the first virtual projection surface 91.

In addition, in the projector priority first mode, in a case in which the position or the parameter of the first virtual projection apparatus 151 is changed, the information processing apparatus 50 resets (sets once again) at least any of the position or the size of the first virtual projection surface 91 and the second installable range 93 of the second virtual projection apparatus. In addition, in a case in which the position of the first virtual projection surface 91 is changed, the information processing apparatus 50 resets (sets once again) the second installable range 93 of the second virtual projection apparatus.

### (Projector Priority Second Mode)

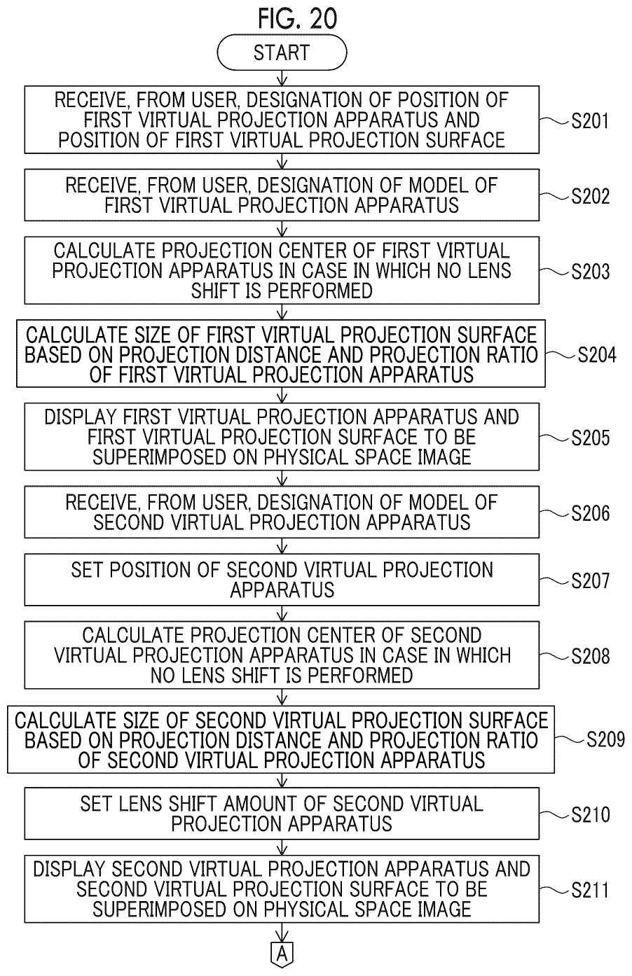

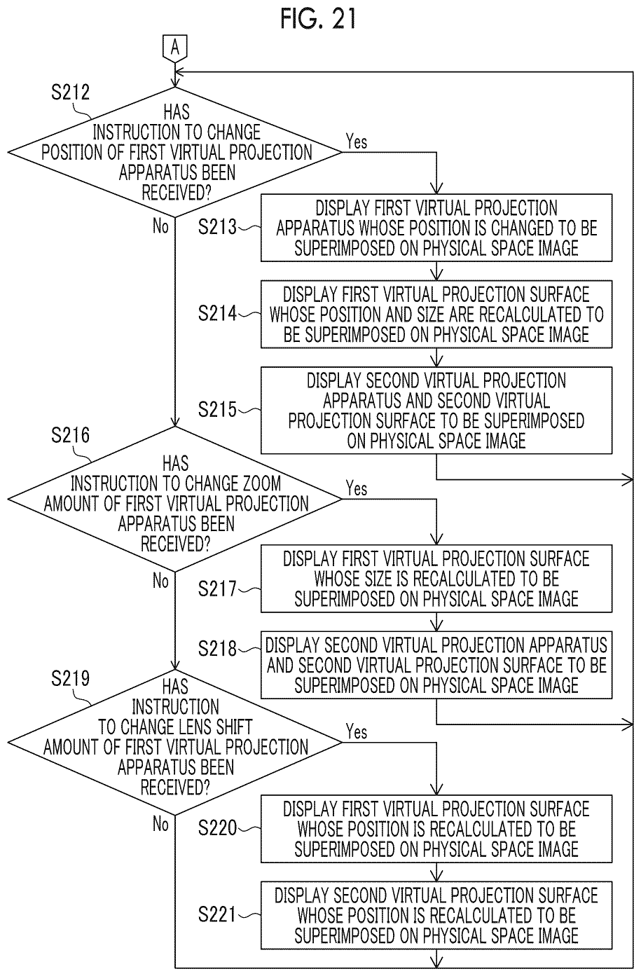

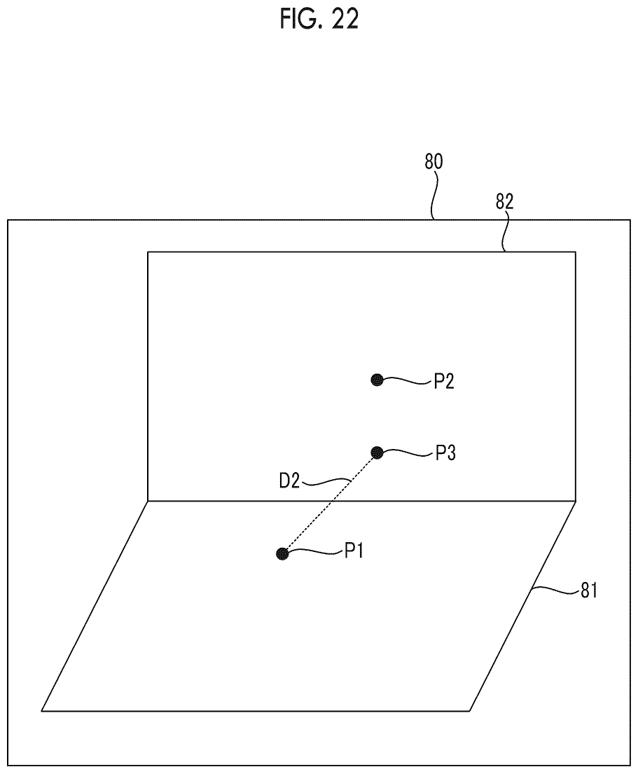

FIGS. 20 and 21 are flowcharts showing an example of processing of the information processing apparatus 50 in the projector priority second mode. FIGS. 22 to 26 are examples of images displayed by the information processing apparatus 50 in the processing shown in FIGS. 20 and 21. As in the case of the screen priority mode, the information processing apparatus 50 displays the physical space image 80 shown in FIG. 8 at the start of the processing shown in FIG. 20. Furthermore, the information processing apparatus 50 recognizes the physical space shown in the physical space image 80 three-dimensionally.

First, as in Step S141 shown in FIG. 14, the information processing apparatus 50 receives, from the user, designation of the position of the first virtual projection apparatus 151 and the position (position of the projection center) of the first virtual projection surface 91 (Step S201). For example, the information processing apparatus 50 receives designation of the position P1 of the first virtual projection apparatus and the position P2 of the first virtual projection surface 91 shown in FIG. 15.

Next, similarly to Step S142 shown in FIG. 14, the information processing apparatus 50 receives, from the user, designation of the model of the first virtual projection apparatus from among a plurality of options of the model of the projection apparatus 10 (Step S202).

Next, the information processing apparatus 50 calculates the position of the projection center of the first virtual projection apparatus 151 in a case in which no lens shift is performed based on the position of the first virtual projection apparatus 151 designated in Step S201 (Step S203). For example, as shown in FIG. 22, the information processing apparatus 50 calculates a position P3 of the projection center of the first virtual projection apparatus 151 in a case in which no lens shift is performed (in a case in which the lens shift amount=0). Further, the information processing apparatus 50 calculates a projection distance D2 that is a distance between the positions P1 and P3.

Next, the information processing apparatus 50 calculates the size of the first virtual projection surface 91 based on the projection distance D2 and the projection ratio corresponding to the model of the first virtual projection apparatus designated in Step S202 (Step S204). For example, the information processing apparatus 50 calculates the size of the projection surface in a case in which the first virtual projection apparatus 151 projects the image to the position P3 without performing lens shift as the size of the first virtual projection surface 91.

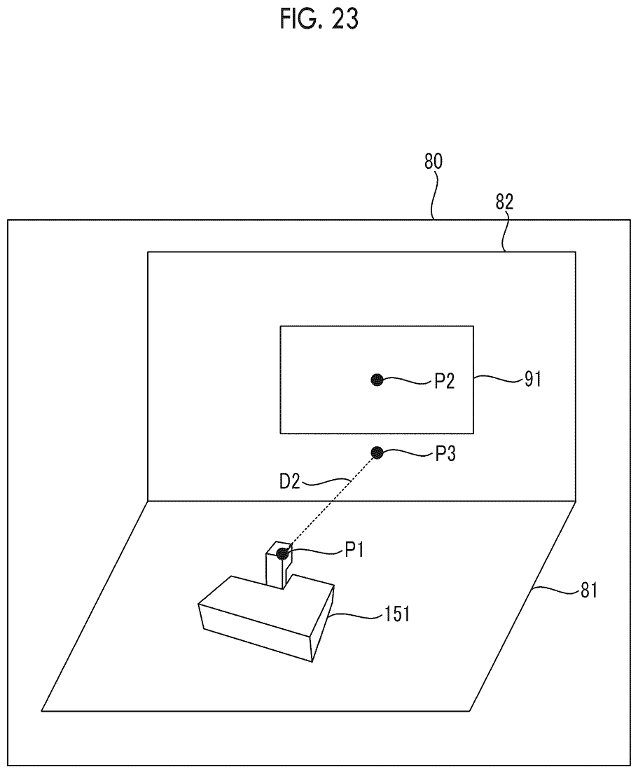

Next, the information processing apparatus 50 displays the first virtual projection apparatus 151 and the first virtual projection surface 91 to be superimposed on the physical space image 80 (Step S205). For example, as shown in FIG. 23, the information processing apparatus 50 displays an image obtained by superimposing the first virtual projection apparatus 151 and the first virtual projection surface 91 on the physical space image 80. The first virtual projection apparatus 151 is a three-dimensional model of the model that has been designated as the model of the first virtual projection apparatus in Step S202.

The first virtual projection apparatus 151 is disposed such that the front lens of the projection lens of the first virtual projection apparatus 151 is at the position P1 shown in FIG. 22. The first virtual projection surface 91 is disposed such that the center position of the first virtual projection surface 91 is at the position P2 shown in FIG. 22. In addition, the size of the first virtual projection surface 91 is the size calculated in Step S204.

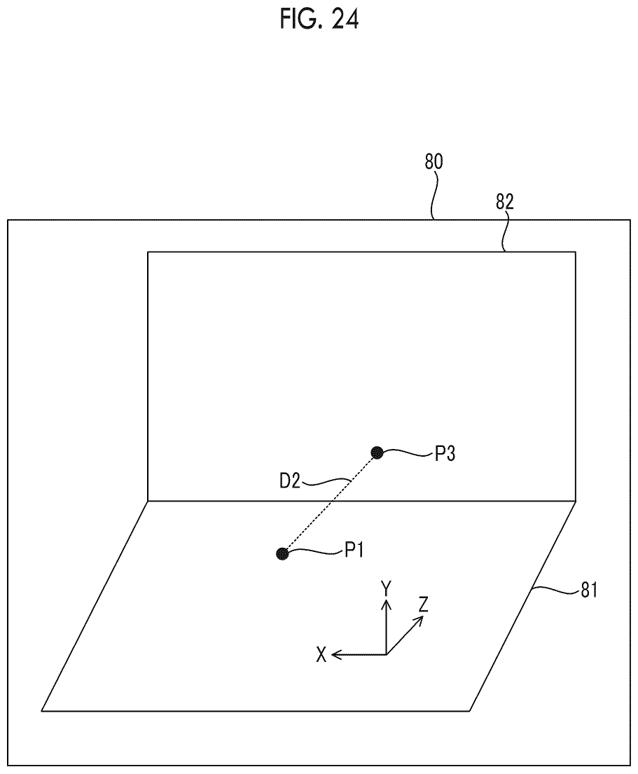

Furthermore, as shown in FIG. 24, the information processing apparatus 50 sets a coordinate system having an axis perpendicular to the bottom surface of the first virtual projection apparatus 151 as a Y-axis, a projection direction of the first virtual projection apparatus 151 as a Z-axis, and an axis orthogonal to the Y-axis and the Z-axis as an X-axis.

Next, the information processing apparatus 50 receives designation of the model of the second virtual projection apparatus from among a plurality of options of the model of the projection apparatus 10 (Step S206). Next, the information processing apparatus 50 sets the position of the second virtual projection apparatus to a position at which an evaluation value obtained by using the distance between the first virtual projection apparatus 151 and the second virtual projection apparatus is minimized, based on the specification of the model that has been designated as the model of the second virtual projection apparatus in Step S206 (Step S207).

This evaluation value is, for example, an evaluation value that decreases as the distance between the first virtual projection apparatus 151 and the second virtual projection apparatus decreases. As the distance between the first virtual projection apparatus 151 and the second virtual projection apparatus, the distance between the lens positions (for example, the position of the front lens) of the first virtual projection apparatus 151 and the second virtual projection apparatus may be used, or the distance between the centers of the bottom surfaces of the first virtual projection apparatus 151 and the second virtual projection apparatus may be used. Here, it is assumed that the above evaluation value is minimized at a position where Y-coordinates of the bottom surfaces of the first virtual projection apparatus 151 and the second virtual projection apparatus match and the X-coordinate and the Z-coordinate of the lens position of the first virtual projection apparatus 151 and the second virtual projection apparatus match. Alternatively, it may be assumed simply that the evaluation value is minimized when the X-coordinate, the Y-coordinate, and the Z-coordinate of the lenses of the first virtual projection apparatus 151 and the second virtual projection apparatus match.

Next, based on the specification of the model that has been designated as the model of the second virtual projection apparatus in Step S206 and the position of the second virtual projection apparatus set in Step S207, the information processing apparatus 50 calculates the position of the projection center of the second virtual projection apparatus in a case in which no lens shift is performed, similarly to the position P3 (Step S208). For example, the information processing apparatus 50 calculates a position P4 of the projection center of the second virtual projection apparatus in a case in which no lens shift is performed (in a case in which the lens shift amount=0). In addition, the information processing apparatus 50 calculates a projection distance D3, which is the distance between the position of the second virtual projection apparatus set in Step S207 and the position P4.

Next, the information processing apparatus 50 calculates the size of the second virtual projection surface by the second virtual projection apparatus, similarly to the calculation of the size of the first virtual projection surface 91 in Step S204 (Step S209). For example, the information processing apparatus 50 calculates the size of the projection surface in a case in which the second virtual projection apparatus projects the image to the position P4 without performing lens shift as the size of the second virtual projection surface.

Furthermore, in a case in which the second virtual projection apparatus has a zoom function, the information processing apparatus 50 sets the projection ratio of the second virtual projection apparatus such that the size of the second virtual projection surface is closest to the size of the first virtual projection surface 91. Moreover, the information processing apparatus 50 sets the lens shift amount of the second virtual projection apparatus such that the distance between the center position of the first virtual projection surface 91 and the center position of the second virtual projection surface is minimized, based on the specification of the model that has been designated as the model of the second virtual projection apparatus in Step S206 (Step S210).

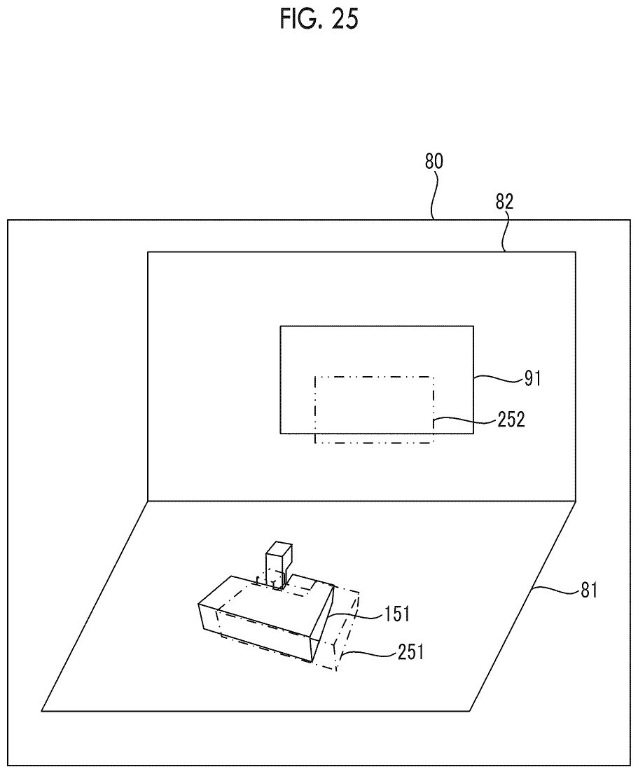

Next, the information processing apparatus 50 displays the second virtual projection apparatus and the second virtual projection surface to be superimposed on the physical space image 80 (Step S211). For example, as shown in FIG. 25, the information processing apparatus 50 displays an image obtained by superimposing the first virtual projection apparatus 151, the first virtual projection surface 91, a second virtual projection apparatus 251, and a second virtual projection surface 252 on the physical space image 80. The second virtual projection apparatus 251 is a three-dimensional model of the model that has been designated as the model of the second virtual projection apparatus in Step S206.

The second virtual projection apparatus 251 is disposed such that the front lens of the projection lens of the second virtual projection apparatus 251 is at the position of the second virtual projection apparatus set in Step S207. The second virtual projection surface 252 is disposed such that the center position of the second virtual projection surface 252 is shifted from the center position of the second virtual projection surface calculated in Step S208 based on the lens shift amount set in Step S210. In addition, the size of the second virtual projection surface 252 is the size calculated in Step S209.

Accordingly, the user can visually ascertain the projection state without resetting the position of the virtual projection apparatus or the virtual projection surface even in a case in which the model is changed, making it easier to select an appropriate model.

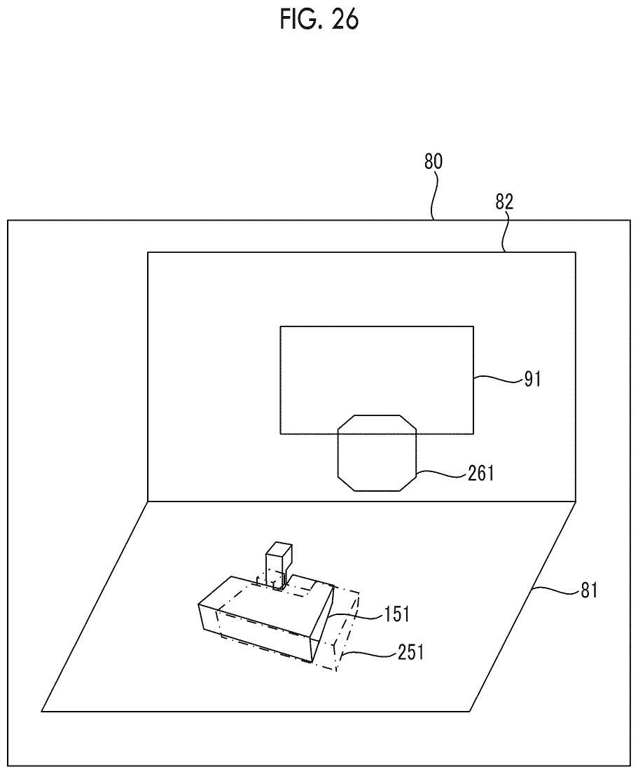

The information processing apparatus 50 may display a range in which the position and size of the first virtual projection surface 91 or the second virtual projection surface 252 can be adjusted by changing the parameters of the first virtual projection apparatus 151 or the second virtual projection apparatus 251. For example, as shown in FIG. 26, the information processing apparatus 50 displays a lens shift range 261 of the second virtual projection apparatus 251 when the size of the first virtual projection surface 91 is closest to the size of the second virtual projection surface 252. The lens shift range 261 is a range centered on the center position of the second virtual projection surface calculated in Step S208.

Accordingly, the user can visually ascertain the settable range of the virtual projection surface in a case in which the model is changed, making it easier to select an appropriate model.

Next, the information processing apparatus 50 determines whether or not an instruction to change the position of the first virtual projection apparatus 151 has been received from the user (Step S212). In a case in which an instruction to change the position of the first virtual projection apparatus 151 has been received (Step S212: Yes), the information processing apparatus 50 changes the position of the first virtual projection apparatus 151 and displays the first virtual projection apparatus 151 whose position is changed to be superimposed on the physical space image 80 (Step S213).

In addition, the information processing apparatus 50 recalculates the position and the size of the first virtual projection surface 91 based on the current position of the first virtual projection apparatus 151 and the projection ratio and the lens shift amount that can be set for the model that has been designated as the model of the first virtual projection apparatus in Step S142. Then, the information processing apparatus 50 displays the first virtual projection surface 91 whose position and size are recalculated to be superimposed on the physical space image 80 (Step S214).

Next, the information processing apparatus 50 recalculates the position of the second virtual projection apparatus 251 such that the distance between the second virtual projection apparatus 251 and the first virtual projection apparatus 151 is minimized. In addition, the information processing apparatus 50 recalculates parameters (for example, a lens shift amount or a zoom amount) of the second virtual projection apparatus 251 such that the difference between the position and the size of the second virtual projection surface 252 and the position and the size of the first virtual projection surface 91 recalculated in Step S214 is minimized. Then, the information processing apparatus 50 displays the second virtual projection apparatus 251 and the second virtual projection surface 252 based on the recalculation results to be superimposed on the physical space image 80 (Step S215), and returns to Step S212.

Accordingly, the user can visually ascertain the projection state of the model (the second virtual projection apparatus 251) as a comparison target without performing an operation other than the position change for the first virtual projection apparatus 151, making it easier to select an appropriate model.

In Step S212, in a case in which an instruction to change the position of the first virtual projection apparatus 151 has not been received (Step S212: No), the information processing apparatus 50 determines whether or not an instruction to change the zoom amount of the first virtual projection apparatus 151 has been received from the user (Step S216). In a case in which an instruction to change the zoom amount of the first virtual projection apparatus 151 has been received (Step S216: Yes), the information processing apparatus 50 recalculates the size of the first virtual projection surface 91 based on the changed zoom amount of the first virtual projection apparatus 151, that is, the projection ratio, and displays the first virtual projection surface 91 whose size is recalculated to be superimposed on the physical space image 80 (Step S217).

Next, the information processing apparatus 50 recalculates the parameters (for example, the zoom amount) of the second virtual projection apparatus 251 such that the difference between the size of the second virtual projection surface 252 and the size of the first virtual projection surface 91 recalculated in Step S217 is minimized. Then, the information processing apparatus 50 displays the second virtual projection apparatus 251 and the second virtual projection surface 252 based on the recalculation results to be superimposed on the physical space image 80 (Step S218), and returns to Step S212.

Accordingly, the user can visually ascertain the projection state of the model (the second virtual projection apparatus 251) as a comparison target without performing an operation other than the change of the zoom amount (projection ratio) for the first virtual projection apparatus 151, making it easier to select an appropriate model.

In Step S216, in a case in which an instruction to change the position of the first virtual projection apparatus 151 has not been received (Step S216: No), the information processing apparatus 50 determines whether or not an instruction to change the lens shift amount of the first virtual projection apparatus 151 (the position of the first virtual projection surface 91) has been received from the user (Step S219). In a case in which an instruction to change the lens shift amount of the first virtual projection apparatus 151 has been received (Step S219: Yes), the information processing apparatus 50 recalculates the position of the first virtual projection surface 91 based on the changed lens shift amount of the first virtual projection apparatus 151, and displays the first virtual projection surface 91 whose position is recalculated to be superimposed on the physical space image 80 (Step S220).

Next, the information processing apparatus 50 sets the lens shift amount of the second virtual projection apparatus 251 such that the distance between the center position of the first virtual projection surface 91 and the center position of the second virtual projection surface 252 is minimized, based on the specification of the model that has been designated as the model of the second virtual projection apparatus in Step S206. Furthermore, the information processing apparatus 50 recalculates the position of the second virtual projection surface 252 based on the set lens shift amount of the second virtual projection apparatus 251. Then, the information processing apparatus 50 displays the second virtual projection surface 252 whose position is recalculated to be superimposed on the physical space image 80 (Step S221), and returns to Step S212.

Accordingly, the user can visually ascertain the projection state of the model (the second virtual projection apparatus 251) as a comparison target without performing an operation other than the change of the lens shift amount of the first virtual projection apparatus 151 (the position of the first virtual projection surface 91), making it easier to select an appropriate model.

In Step S219, in a case in which an instruction to change the lens shift amount of the first virtual projection apparatus 151 has not been received (Step S219: No), the information processing apparatus 50 returns to Step S212.

In this way, in the projector priority second mode, the information processing apparatus 50 displays a second image including the first virtual projection surface 91, the first virtual projection apparatus 151, the second virtual projection apparatus 251, and the second virtual projection surface 252 corresponding to the second virtual projection apparatus 251. Furthermore, the information processing apparatus 50 sets the position of the second virtual projection surface 252 and the position of the second virtual projection apparatus 251 based on the position of the first virtual projection apparatus 151 and the position of the first virtual projection surface 91.

In addition, in the projector priority second mode, the information processing apparatus 50 sets the size of the first virtual projection surface 91 based on the position of the first virtual projection apparatus 151 and the position of the first virtual projection surface 91, and sets the position of the second virtual projection apparatus 251 (for example, sets a position as close as possible) based on the position of the first virtual projection apparatus 151. Then, the information processing apparatus 50 sets the parameters (such as the lens shift amount and zoom amount) of the second virtual projection apparatus 251 related to the position and the size of the second virtual projection surface 252 (for example, sets the position and the size of the first virtual projection surface 91 and the second virtual projection surface 252 as close as possible) based on the position and the size of the first virtual projection surface 91.

In addition, the information processing apparatus 50 may perform processing of including, in the second image, an image (for example, the lens shift range 261) indicating a range in which at least any of the position or the size of the first virtual projection surface 91 or the second virtual projection surface 252 can be adjusted by changing the parameters of the first virtual projection apparatus 151 or the second virtual projection apparatus 251.

### (Projector Priority Third Mode)

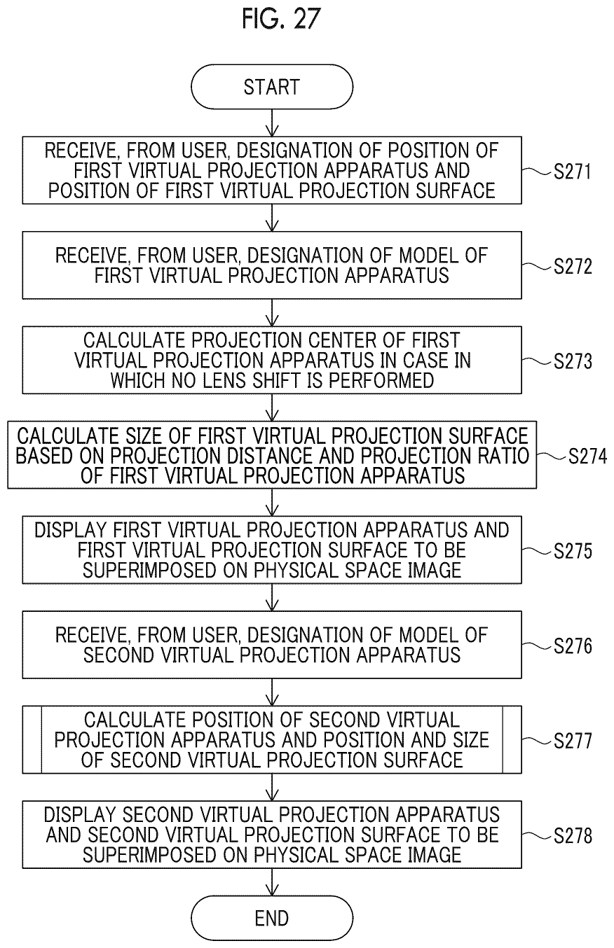

FIG. 27 is a flowchart showing an example of processing of the information processing apparatus 50 in the projector priority third mode. As in the case of the screen priority mode, the information processing apparatus 50 displays the physical space image 80 shown in FIG. 8 at the start of the processing shown in FIG. 27. Furthermore, the information processing apparatus 50 recognizes the physical space shown in the physical space image 80 three-dimensionally.

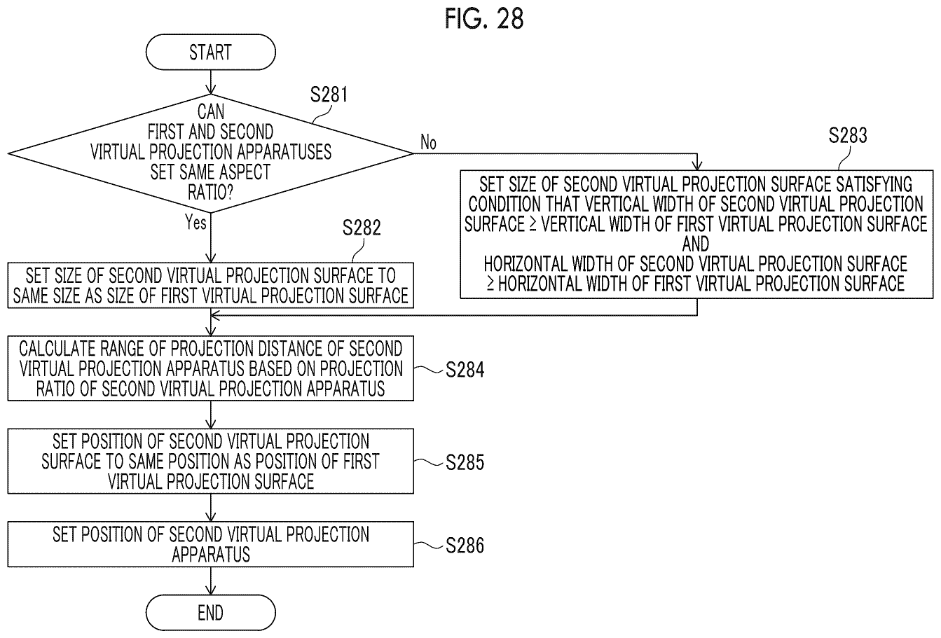

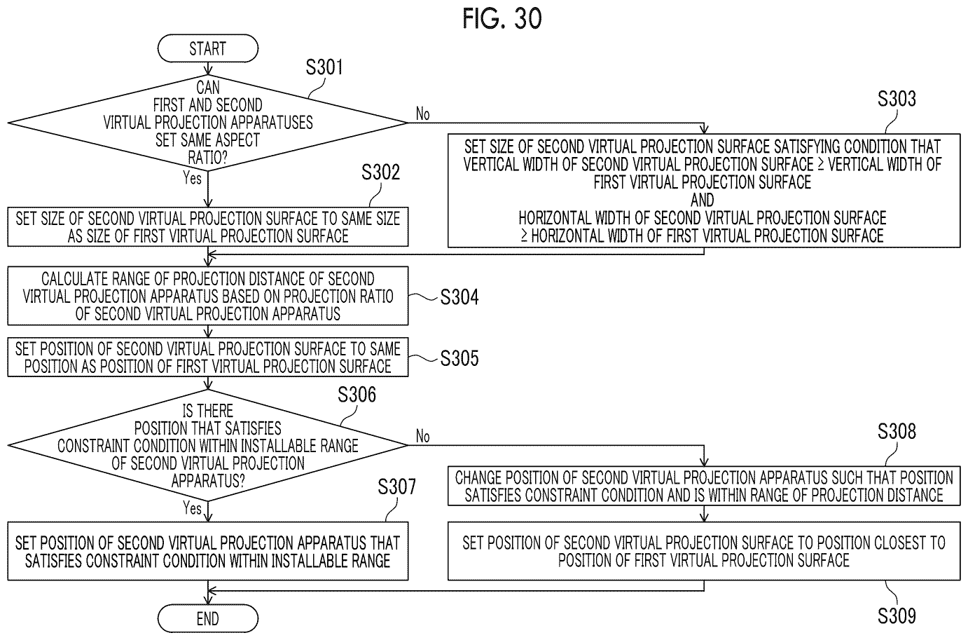

Steps S271 to S276 shown in FIG. 27 are similar to Steps S201 to S206 shown in FIG. 20. After Step S276, the information processing apparatus 50 calculates the position of the second virtual projection apparatus 251 and the position and the size of the second virtual projection surface 252 based on the specification of the model that has been designated as the model of the second virtual projection apparatus in Step S276 (Step S277). The calculation in Step S277 will be described later with reference to FIGS. 28 and 30.

Next, the information processing apparatus 50 displays the second virtual projection apparatus 251 and the second virtual projection surface 252 to be superimposed on the physical space image 80 (Step S278), and ends the series of processes. After Step S278, the information processing apparatus 50 may perform processes based on various change instructions, similarly to Steps S212 to S221 shown in FIG. 21.

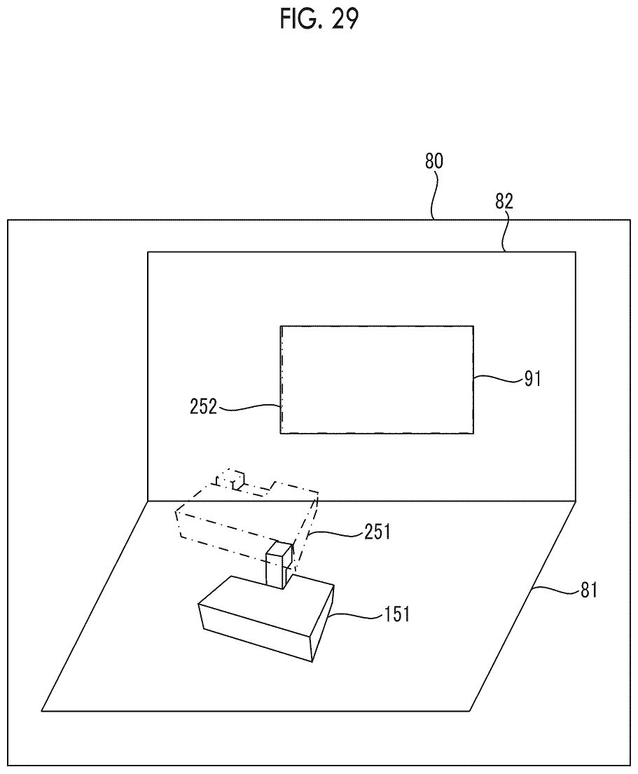

FIG. 28 is a flowchart showing an example of the calculation in Step S277 in FIG. 27. FIG. 29 is an example of an image displayed by the information processing apparatus 50 in the processing shown in FIG. 27 in the example of FIG. 28. In Step S277 in FIG. 27, the information processing apparatus 50 executes, for example, the process shown in FIG. 28.

First, the information processing apparatus 50 determines whether or not the first virtual projection apparatus 151 and the second virtual projection apparatus 251 can set the same aspect ratio to each other (Step S281). The determination in Step S281 is made based on, for example, the models of the first virtual projection apparatus 151 and the second virtual projection apparatus 251 designated in Steps S272 and S276 in FIG. 27.

In Step S281, in a case in which the first virtual projection apparatus 151 and the second virtual projection apparatus 251 can set the same aspect ratio to each other (Step S281: Yes), the information processing apparatus 50 sets the size of the second virtual projection surface 252 to the same size as the size of the first virtual projection surface 91 calculated in Step S274 in FIG. 27 (Step S282).

In Step S281, in a case in which the first virtual projection apparatus 151 and the second virtual projection apparatus 251 cannot set the same aspect ratio to each other (Step S281: No), the information processing apparatus 50 sets the size of the second virtual projection surface 252 in which the vertical width of the second virtual projection surface 252 is equal to or greater than the vertical width of the first virtual projection surface 91 and the horizontal width of the second virtual projection surface 252 is equal to or greater than the horizontal width of the first virtual projection surface 91 (Step S283).

Next, the information processing apparatus 50 calculates a possible range of the projection distance of the second virtual projection apparatus 251 based on the projection ratio of the model that has been designated as the model of the second virtual projection apparatus in Step S206 (Step S284). Furthermore, the information processing apparatus 50 sets the position of the second virtual projection surface 252 to the same position as the position of the first virtual projection surface 91 (Step S285).

Next, the information processing apparatus 50 sets the position of the second virtual projection apparatus 251 (Step S286), and ends Step S277 in FIG. 27. Specifically, in Step S286, the information processing apparatus 50 sets the position of the second virtual projection apparatus 251 such that the distance between the first virtual projection apparatus 151 and the second virtual projection apparatus 251 is minimized from within the installation candidate range of the second virtual projection apparatus 251 determined from the position of the second virtual projection surface 252 set in Step S285 and the possible range of the projection distance of the second virtual projection apparatus 251 calculated in Step S284.

In the example of FIG. 28, in Step S278 in FIG. 27, for example, the information processing apparatus 50 displays the first virtual projection surface 91 and the second virtual projection surface 252 of which the center positions match, and the first virtual projection apparatus 151 and the second virtual projection surface 252 corresponding to these, as shown in FIG. 29. In the example of FIG. 29, the bottom surface of the first virtual projection apparatus 151 and the bottom surface of the second virtual projection apparatus 251 are not on the same plane.

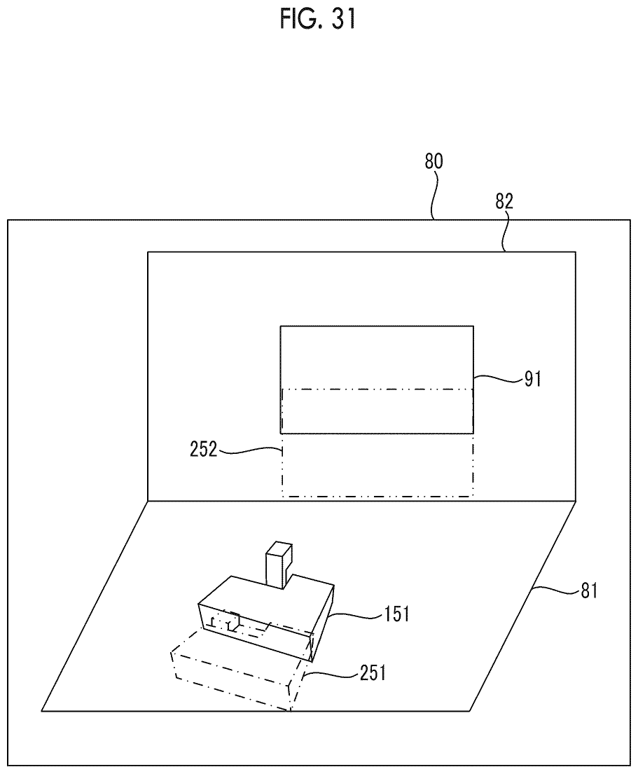

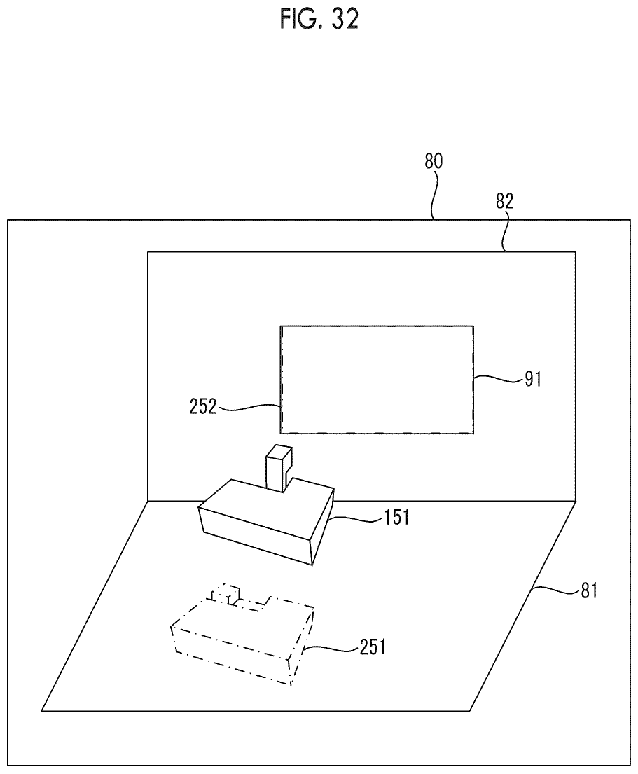

FIG. 30 is a flowchart showing another example of the calculation in Step S277 in FIG. 27. FIGS. 31 and 32 are examples of images displayed by the information processing apparatus 50 in the processing shown in FIG. 27 in the example of FIG. 30. In the case of setting a constraint condition related to the position of the second virtual projection apparatus 251, in Step S277 in FIG. 27, the information processing apparatus 50 executes, for example, the process shown in FIG. 30.

Steps S301 to S305 shown in FIG. 30 are similar to Steps S281 to S285 shown in FIG. 28. Next to Step S305, the information processing apparatus 50 determines whether or not there is a position that satisfies the constraint condition within the installable range of the second virtual projection apparatus 251 (Step S306). In a case in which there is a position that satisfies the constraint condition within the installable range of the second virtual projection apparatus 251 (Step S306: Yes), the information processing apparatus 50 sets a position of the second virtual projection apparatus 251 that satisfies the constraint condition within the installable range of the second virtual projection apparatus 251 (Step S307), and ends Step S277 in FIG. 27.

In Step S306, in a case in which there is no position that satisfies the constraint condition within the installable range of the second virtual projection apparatus 251 (Step S306: No), the information processing apparatus 50 changes the position of the second virtual projection apparatus 251 such that the position satisfies the constraint condition and is within the range of the projection distance calculated in Step S304 (Step S308).

Next, the information processing apparatus 50 sets the position (center position) of the second virtual projection surface 252 to the position (center position) closest to the position of the first virtual projection surface 91 (Step S309), and ends Step S277 in FIG. 27.

For example, in the example of FIG. 31, it is assumed that a constraint condition is set such that the bottom surface of the first virtual projection apparatus 151 and the bottom surface of the second virtual projection apparatus 251 are on the same plane. Furthermore, in the second virtual projection apparatus 251, in a case in which the position (center position) of the second virtual projection surface 252 and the position (center position) of the first virtual projection surface 91 are set to the same position, it is assumed that there is no position that satisfies this constraint condition within the installable range of the second virtual projection apparatus 251. In this case, in Step S278 in FIG. 27, the information processing apparatus 50 displays, for example, as shown in FIG. 31, the first virtual projection apparatus 151, the second virtual projection apparatus 251 having the bottom surface on the same plane as the bottom surface of the first virtual projection apparatus 151, the first virtual projection surface 91, and the second virtual projection surface 252 that can be projected from the second virtual projection apparatus 251 and is close to the first virtual projection surface 91.

In the example of FIG. 30, it is also assumed that a constraint condition is set such that the bottom surface of second virtual projection apparatus 251 is on a physical plane. Also, it is assumed that the position of the first virtual projection apparatus 151 is set at a position where the bottom surface of the first virtual projection apparatus 151 is on a plane different from the floor 81 (physical plane). Furthermore, in a case in which the lens shift range of the second virtual projection apparatus 251 is sufficiently large and the position (center position) of the second virtual projection surface 252 and the position (center position) of the first virtual projection surface 91 are set to the same position, it is assumed that the installable range of the second virtual projection apparatus 251 overlaps the floor 81. In this case, in Step S278 in FIG. 27, the information processing apparatus 50 displays, for example, the first virtual projection apparatus 151, the second virtual projection apparatus 251 of which the bottom surface is on the floor 81, and the first virtual projection surface 91 and the second virtual projection surface 252 of which the positions match, as shown in FIG. 32.

Accordingly, the user can visually ascertain the difference in the positions of the virtual projection apparatus when the virtual projection surfaces of as similar sizes as possible are disposed using different models of the virtual projection apparatuses, making it easier to select an appropriate model.

In this way, in the projector priority third mode, the information processing apparatus 50 displays a second image including the first virtual projection surface 91, the first virtual projection apparatus 151, the second virtual projection apparatus 251, and the second virtual projection surface 252 corresponding to the second virtual projection apparatus 251, similarly to the projector priority second mode. Furthermore, the information processing apparatus 50 sets the position of the second virtual projection surface 252 and the position of the second virtual projection apparatus 251 based on the position of the first virtual projection apparatus 151 and the position of the first virtual projection surface 91.

In addition, in the projector priority third mode, the information processing apparatus 50 sets the size of the first virtual projection surface 91 based on the position of the first virtual projection apparatus 151 and the position of the first virtual projection surface 91, and sets the position and the size of the second virtual projection surface 252 (for example, sets a position and a size as close as possible) based on the position and the size of the first virtual projection surface 91. Then, the information processing apparatus 50 sets the position of the second virtual projection surface 252 (for example, sets the positions of the first virtual projection surface and the second virtual projection surface as close as possible) based on the position of the first virtual projection apparatus 151.

In addition, in the projector priority third mode, after the respective positions and sizes of the first virtual projection apparatus 151 and the first virtual projection surface 91 are determined, the second virtual projection apparatus 251 and the second virtual projection surface 252 are set using these positions as constraints, but the information processing apparatus 50 may release this constraint in accordance with predetermined conditions such as instructions from the user. In a case in which this constraint is released, the information processing apparatus 50 sets the position and the size of the second virtual projection apparatus 251 and the second virtual projection surface 252 in accordance with instructions from the user, independently of the position and the size of the first virtual projection apparatus 151 and the first virtual projection surface 91. In other words, the information processing apparatus 50 may be capable of switching between a state in which the second virtual projection apparatus 251 and the second virtual projection surface 252 are set according to constraints based on the settings of the first virtual projection apparatus 151 and the first virtual projection surface 91, and a state in which the second virtual projection apparatus 251 and the second virtual projection surface 252 are set without those constraints.

As described above, the information processing apparatus 50 displays a second image in which the first virtual projection surface 91, the first virtual projection apparatus 151 or the first installable range 92, and the second virtual projection apparatus 251 or the second installable range 93 are displayed in the physical space image 80, thereby improving the convenience for the user in selecting the model of the projection apparatus to be installed.

### (Model Search Mode)

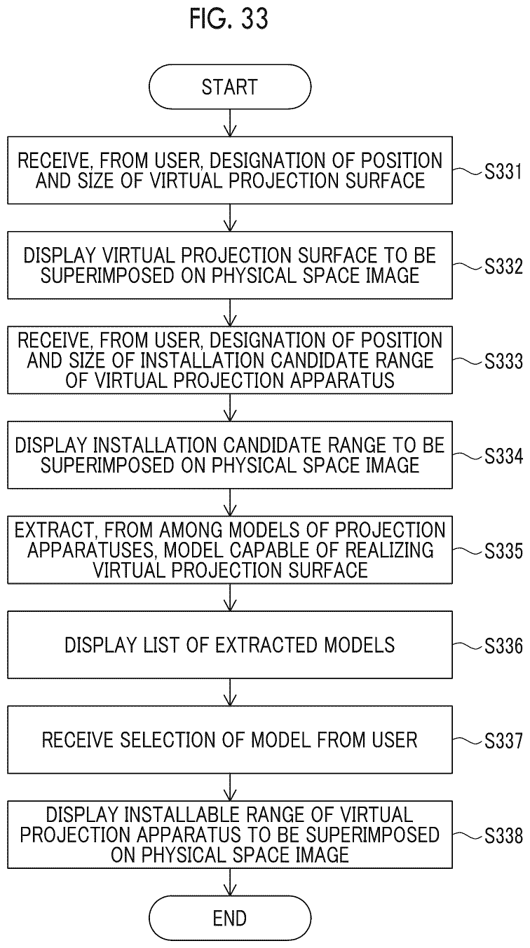

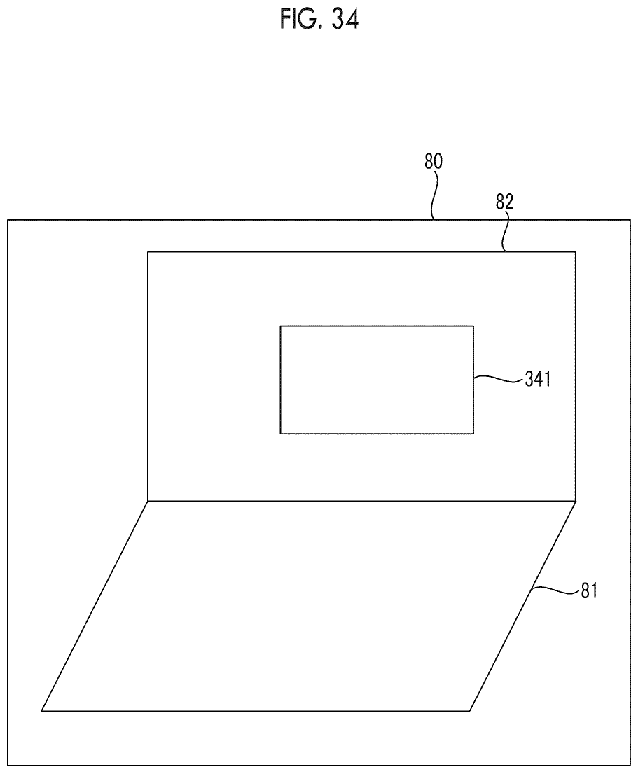

FIG. 33 is a flowchart showing an example of processing of the information processing apparatus 50 in the model search mode. FIGS. 34 to 38 are examples of images displayed by the information processing apparatus 50 in the processing shown in FIG. 33. As in the processing shown in FIG. 7 and the like, the information processing apparatus 50 displays the physical space image 80 shown in FIG. 8 at the start of the processing shown in FIG. 33. Furthermore, the information processing apparatus 50 recognizes the physical space shown in the physical space image 80 three-dimensionally.

First, the information processing apparatus 50 receives, from the user, designation of the position and the size of the virtual projection surface (Step S331). Next, the information processing apparatus 50 displays the virtual projection surface to be superimposed on the physical space image 80 based on the designation received in Step S331 (Step S332). The process of displaying an image in which the virtual projection surface is superimposed on the physical space image 80 is similar to the process of displaying an image in which the virtual projection surface is superimposed on the physical space image 80 shown in FIG. 9, for example. For example, as shown in FIG. 34, the information processing apparatus 50 displays an image obtained by superimposing a virtual projection surface 341 on the physical space image 80.

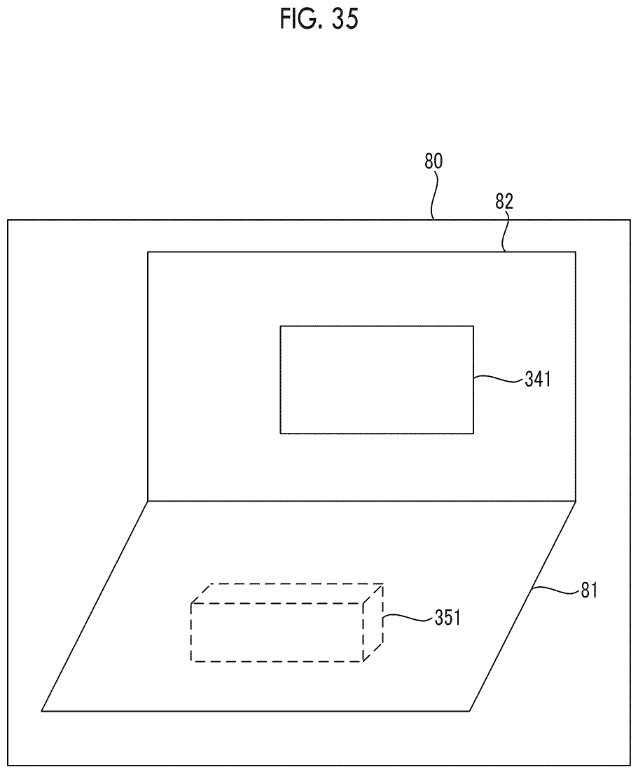

Next, the information processing apparatus 50 receives, from the user, designation of the position and the size of the installation candidate range, which is a range in which is desired to install the virtual projection apparatus (Step S333). Next, the information processing apparatus 50 displays the installation candidate range designated in Step S333 to be superimposed on the physical space image 80 (Step S334). For example, as shown in FIG. 35, the information processing apparatus 50 displays an image obtained by superimposing the virtual projection surface 341 and an installation candidate range 351 on the physical space image 80. In this example, the installation candidate range 351 is a rectangular parallelepiped.

Next, the information processing apparatus 50 extracts, from among the registered models of projection apparatuses, a model capable of realizing the virtual projection surface 341 at the position and the size designated in Step S331 (Step S335). For example, the information processing apparatus 50 determines whether or not the virtual projection surface 341 can be realized by disposing each registered model of the projection apparatus within the installation candidate range 351 designated in Step S333 and setting the parameters of the model (for example, a lens shift amount and a zoom amount), thereby performing extraction in Step S335.

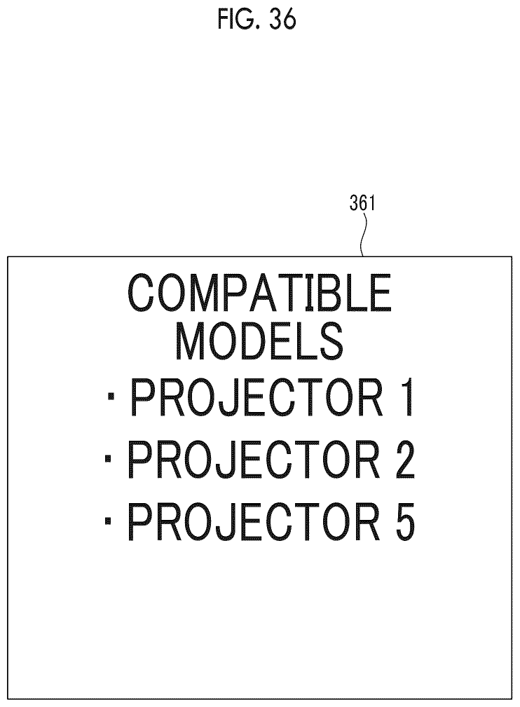

Next, the information processing apparatus 50 displays a list of the models extracted in Step S335 (Step S336). For example, the information processing apparatus 50 displays a compatible model list 361 shown in FIG. 36. In this example, the compatible model list 361 indicates “projector 1”, “projector 2”, and “projector 5” as models capable of realizing the virtual projection surface 341 (compatible models). Note that the information processing apparatus 50 may display the compatible model list 361 instead of the image shown in FIG. 34, or may display the compatible model list 361 simultaneously with the image shown in FIG. 34.

Accordingly, the user can narrow down the compatible models for the installation candidate range 351 in which the projection apparatus is to be installed, making it easier to select the appropriate model.

Next, the information processing apparatus 50 receives, from the user, selection of the model of the virtual projection apparatus from the list displayed in Step S336 (Step S337).

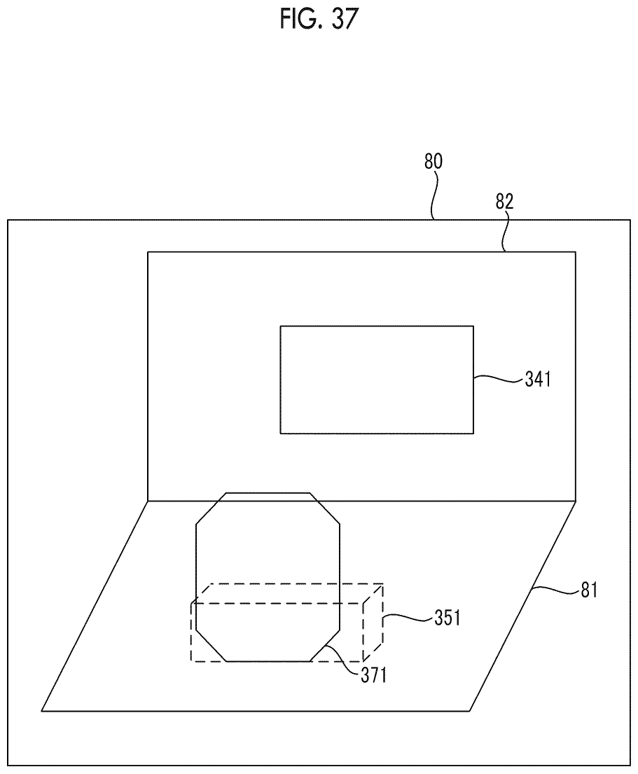

Next, the information processing apparatus 50 calculates the position and the size of the installable range based on the position and the size of the virtual projection surface 341 designated in Step S331 and the projection ratio and the lens shift amount that can be set for the model that has been designated as the model of the virtual projection apparatus in Step S337. Then, the information processing apparatus 50 displays the installable range whose position and size are calculated to be superimposed on the physical space image 80 (Step S338). For example, as shown in FIG. 37, the information processing apparatus 50 displays an image obtained by superimposing the virtual projection surface 341, the installation candidate range 351, and an installable range 371 on the physical space image 80. In this example, the installation candidate range 351 is a rectangular parallelepiped. In this case, the information processing apparatus 50 may limit the installable range 371 to only a region overlapping with the installation candidate range 351 designated by the user and display the region.

Accordingly, the user can visually ascertain the installable range limited by the model under consideration for installation, making it easier to select an appropriate model.

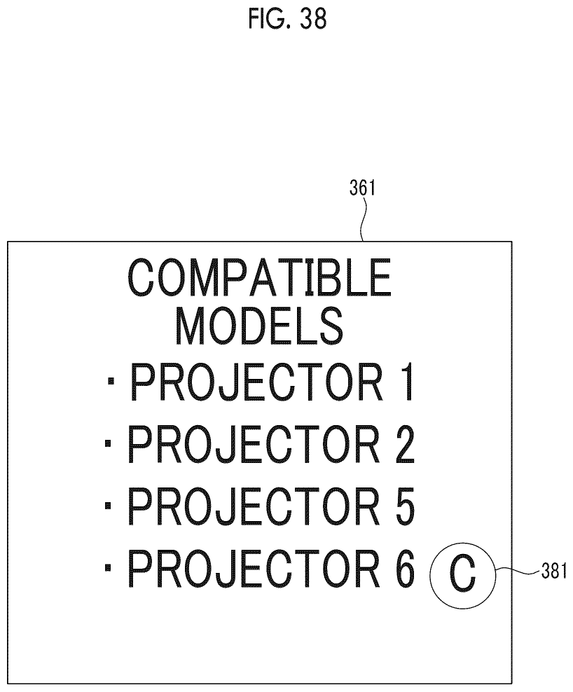

In addition, in Step S335 in FIG. 33, the information processing apparatus 50 may determine whether or not the virtual projection surface 341 can be realized by disposing each registered model of the projection apparatus within the installation candidate range 351 designated in Step S333 and setting the parameters of the model, for each with or without cropping. Then, in Step S336, the information processing apparatus 50 may display candidates of models capable of realizing the virtual projection surface 341 by distinguishing between candidates of models capable of realizing the virtual projection surface 341 without cropping and candidates of models capable of realizing the virtual projection surface 341 with cropping. For example, the information processing apparatus 50 displays a compatible model list 361 shown in FIG. 38. In this example, the compatible model list 361 indicates “projector 1”, “projector 2”, “projector 5”, and “projector 6” as models capable of realizing the virtual projection surface 341 (compatible models). Among these, it is assumed that “projector 1”, “projector 2”, and “projector 5” are models capable of realizing the virtual projection surface 341 without cropping, and “projector 6” is a model capable of realizing the virtual projection surface 341 with cropping. In this case, in the compatible model list 361, a crop mark 381 is added to “projector 6” indicating that it is a model capable of realizing the virtual projection surface 341 with cropping.

Accordingly, the user can ascertain a model that requires adjustment and a model that does not require adjustment among compatible models for a range in which the projection apparatus is to be installed, making it easier to select an appropriate model.

In this way, in the model search mode, the information processing apparatus 50 outputs the compatible model list 361 which are candidates of models of projection apparatuses that can project onto the range of the virtual projection surface 341 by being installed in the installation candidate range 351 of the projection apparatus, based on the designation of the position and the size (range) of the virtual projection surface 341 (projection surface) and the installation candidate range 351 of the projection apparatus received from the user based on the physical space image 80 (a third image) captured by the imaging apparatus of the sensor 65.

Furthermore, in the model search mode, the information processing apparatus 50 may limit the installable range 371 of the projection apparatus to a region overlapping with the installation candidate range 351 of the projection apparatus and display the region on the physical space image 80. In addition, in the model search mode, the information processing apparatus 50 may output the compatible model list 361 together with a usage condition of the projection apparatus candidates (for example, whether cropping is required).

Furthermore, the information processing apparatus 50 may execute the process of the model search mode in combination with the process of the above-mentioned screen priority mode, projector priority first mode, projector priority second mode, or projector priority third mode. For example, in the above-mentioned screen priority mode, projector priority first mode, projector priority second mode, or projector priority third mode, the information processing apparatus 50 may execute a process of receiving designation of the model of the projection apparatus from among the candidates output in the model search mode, instead of the process of receiving designation of the model of the first virtual projection apparatus and the second virtual projection apparatus.

As described above, the information processing apparatus 50 outputs the compatible model list 361 which are candidates of models of projection apparatuses that can project onto the range of the virtual projection surface 341 by being installed in the installation candidate range 351 of the projection apparatus, based on the designation of the position and the size (range) of the virtual projection surface 341 (projection surface) and the installation candidate range 351 of the projection apparatus received from the user based on the physical space image 80 (third image), thereby improving the convenience for the user in selecting the model of the projection apparatus to be installed.

### MODIFICATION EXAMPLE

Modification examples related to each embodiment will be described.

### Modification Example 1

Although a case in which the physical space image 80 indicating the physical space is a through-image showing an image obtained by imaging using an imaging apparatus provided in the information processing apparatus 50 in real time has been described, the physical space image 80 is not limited thereto. For example, the physical space image 80 may be a still image obtained by imaging the physical space in the past. Furthermore, the physical space image 80 may not be an image obtained by imaging and may be, for example, an image generated based on three-dimensional data indicating the structure of the physical space.

### Modification Example 2

Although a case in which the information processing apparatus 50 is a tablet terminal having a touch panel 51 has been described, the information processing apparatus 50 is not limited to such a configuration. For example, the information processing apparatus 50 may be an information terminal, such as a smartphone or a personal computer.

### Modification Example 3

Although the configuration in which the information processing apparatus 50 displays the second image has been described, the information processing apparatus 50 may transmit the generated second image to another apparatus to perform control to display the second image on the other apparatus. In this case, the information processing apparatus 50 may be a server apparatus that does not comprise a display device.

### Modification Example 4

Although a case in which the physical space image 80 is an image obtained by imaging using an imaging apparatus of the information processing apparatus 50 has been described, the physical space image 80 may be an image obtained by imaging using an apparatus different from the information processing apparatus 50 and received by the information processing apparatus 50 from the apparatus. In this case, the information processing apparatus 50 may be an apparatus that does not comprise an imaging apparatus.

### Modification Example 5

In the projector priority second mode and the projector priority third mode, in a case in which the installation state of the first virtual projection apparatus 151 (for example, whether the first virtual projection apparatus 151 is placed on a floor or hung from a ceiling) or the position of the second virtual projection apparatus 251 is changed by the user designation after displaying the second image, the information processing apparatus 50 may reset (may set once again) at least any of the installation state of the second virtual projection apparatus 251, a parameter (for example, a lens shift amount or a zoom amount) of the second virtual projection apparatus 251, or the position of the second virtual projection surface 252.

### Modification Example 6

In the case of displaying the second image, the information processing apparatus 50 may perform control to make the visibility of some objects lower than the visibility of the other objects in objects (the first virtual projection surface 91, the first virtual projection apparatus 151 or the first installable range 92, and the second virtual projection apparatus 251 or the second installable range 93) to be superimposed on the second image. For example, the information processing apparatus 50 performs control to reduce the visibility of the first virtual projection apparatus 151 by setting the opacity of the first virtual projection apparatus 151 to be higher than the opacities of the first virtual projection surface 91 and the second installable range 93 among the first virtual projection surface 91, the first virtual projection apparatus 151, and the second installable range 93 included in the second image shown in FIG. 17. The object that reduces the visibility in the objects may be selected by, for example, a user operation, or may be automatically selected based on various types of information (for example, a parameter of the projection apparatus, a position of the imaging apparatus of the information processing apparatus 50, an order of the operation, and the like) that can be acquired by the information processing apparatus 50.

### Modification Example 7

Although a case in which the second image is a still image including the first virtual projection surface 91, the first virtual projection apparatus 151 or the first installable range 92, and the second virtual projection apparatus 251 or the second installable range 93 has been described. However, the second image may be a moving image in which the first virtual projection surface 91, the first virtual projection apparatus 151 or the first installable range 92, and the second virtual projection apparatus 251 or the second installable range 93 are alternately displayed.

The information processing method described in the above embodiment can be implemented by executing an information processing program prepared in advance on a computer. This information processing program is recorded in a computer-readable storage medium and is executed by being read from the storage medium by a computer. In addition, this information processing program may be provided in a form of being stored in a non-transitory storage medium, such as a flash memory, or may be provided via a network, such as the Internet. The computer that executes this information processing program may be included in an information processing apparatus, may be included in an electronic apparatus such as a smartphone, a tablet terminal, or a personal computer capable of communicating with the information processing apparatus, or may be included in a server apparatus capable of communicating with the information processing apparatus and the electronic apparatus.

The embodiments and the modification examples can be implemented in combination with each other.

At least the following matters are described in the present specification.

(1)

An information processing apparatus comprising a processor,
in which the processor is configured to:
   acquire first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
   generate second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and
   output the second image data to an output destination.
      (2)

The information processing apparatus according to (1),
in which the second image includes the first virtual projection surface, the installable range of the first virtual projection apparatus, and the installable range of the second virtual projection apparatus, and
the processor is configured to set the installable range of the first virtual projection apparatus and the installable range of the second virtual projection apparatus based on at least any of a position or a size of the first virtual projection surface.
   (3)

The information processing apparatus according to (2),
in which the processor is configured to reset (set once again) the installable range of the first virtual projection apparatus and the installable range of the second virtual projection apparatus in a case in which at least any of the position or the size of the first virtual projection surface is changed.
   (4)

The information processing apparatus according to (1),
in which the second image includes the first virtual projection surface, the first virtual projection apparatus, and the installable range of the second virtual projection apparatus, and
the processor is configured to:
   set at least any of a position or a size of the first virtual projection surface based on a position of the first virtual projection apparatus; and
   set the installable range of the second virtual projection apparatus based on at least any of the position or the size of the first virtual projection surface.
      (5)

The information processing apparatus according to (4),
in which the processor is configured to reset (set once again) at least any of the position or the size of the first virtual projection surface and the installable range of the second virtual projection apparatus in a case in which the position or a parameter of the first virtual projection apparatus is changed.
   (6)

The information processing apparatus according to (4) or (5),
in which the processor is configured to reset (set once again) the installable range of the second virtual projection apparatus in a case in which the position of the first virtual projection surface is changed.
   (7)

The information processing apparatus according to (1),
in which the second image includes the first virtual projection surface, the first virtual projection apparatus, the second virtual projection apparatus, and a second virtual projection surface corresponding to the second virtual projection apparatus, and
the processor is configured to set a position of the second virtual projection surface and a position of the second virtual projection apparatus based on a position of the first virtual projection apparatus and a position of the first virtual projection surface.
   (8)

The information processing apparatus according to (7),
in which the processor is configured to:
   set a size of the first virtual projection surface based on the position of the first virtual projection apparatus and the position of the first virtual projection surface;
   set the position of the second virtual projection apparatus based on the position of the first virtual projection apparatus; and
   set a parameter of the second virtual projection surface related to the position and a size of the second virtual projection surface based on the position and the size of the first virtual projection surface.
      (9)

The information processing apparatus according to (7),
in which the processor is configured to:
   set a size of the first virtual projection surface based on the position of the first virtual projection apparatus and the position of the first virtual projection surface;
   set the position and a size of the second virtual projection surface based on the position and the size of the first virtual projection surface; and
   set a parameter of the second virtual projection surface related to the position of the second virtual projection surface based on the position of the first virtual projection apparatus.
      (10)

The information processing apparatus according to any one of (7) to (9),
in which the processor is configured to perform a process of including, in the second image, an image indicating a range in which at least any of the position of the first virtual projection surface or the position of the second virtual projection surface, or a size of the first virtual projection surface or a size of the second virtual projection surface is adjustable by changing a parameter of the first virtual projection apparatus or the second virtual projection apparatus.
   (11)

The information processing apparatus according to any one of (7) to (10),
in which the processor is configured to reset (set once again) at least any of an installation state of the second virtual projection apparatus, a parameter of the second virtual projection apparatus, or the position of the second virtual projection surface in a case in which an installation state of the first virtual projection apparatus or the position of the second virtual projection apparatus is changed.
   (12)

The information processing apparatus according to any one of (7) to (11),
in which the processor is configured to switch between a state of performing a setting of the second virtual projection apparatus and the second virtual projection surface according to a constraint based on a setting of the first virtual projection apparatus and the first virtual projection surface, and a state of performing the setting of the second virtual projection apparatus and the second virtual projection surface without the constraint.
   (13)

The information processing apparatus according to any one of (1) to (12),
in which the processor is configured to output projection apparatus candidates capable of projecting onto a range of a projection surface by being installed in an installation range of the projection apparatus based on designation of the range of the projection surface and the installation range of the projection apparatus received from a user based on a third image captured by the imaging apparatus, and
the first virtual projection apparatus and the second virtual projection apparatus are virtual projection apparatuses indicating each projection apparatus selected by the user from among the projection apparatus candidates.
   (14)

The information processing apparatus according to (13),
in which the processor is configured to limit the installable range of at least any of the first virtual projection apparatus or the second virtual projection apparatus to a region overlapping with the installation range of the projection apparatus and display the region on the first image.
   (15)

The information processing apparatus according to (13) or (14),
in which the processor is configured to output the projection apparatus candidates together with a usage condition of the projection apparatus candidates.
   (16)

The information processing apparatus according to any one of (1) to (15),
in which the processor is configured to, in the second image, perform control to make visibility of some objects lower than visibility of other objects in the first virtual projection surface, the first virtual projection apparatus or the installable range of the first virtual projection apparatus, and the second virtual projection apparatus or the installable range of the second virtual projection apparatus.
   (17)

An information processing method performed by a processor of an information processing apparatus, the method comprising:
acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
generating second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and
outputting the second image data to an output destination.
   (18)

An information processing program for causing a processor of an information processing apparatus to execute a process comprising:
acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
generating second image data representing a second image in which the first virtual projection surface, the first virtual projection apparatus or an installable range of the first virtual projection apparatus, and the second virtual projection apparatus or an installable range of the second virtual projection apparatus are displayed on the first image based on the first virtual projection surface data, the first virtual projection apparatus data, and the second virtual projection apparatus data; and
outputting the second image data to an output destination.
   (19)

An information processing apparatus comprising a processor,
in which the processor is configured to output projection apparatus candidates capable of projecting onto a range of a projection surface by being installed in an installation range of a projection apparatus based on designation of the range of the projection surface and the installation range of the projection apparatus received from a user based on an image captured by an imaging apparatus.
   (20)

An information processing method performed by a processor of an information processing apparatus, the method comprising:
outputting projection apparatus candidates capable of projecting onto a range of a projection surface by being installed in an installation range of a projection apparatus based on designation of the range of the projection surface and the installation range of the projection apparatus received from a user based on an image captured by an imaging apparatus.
   (21)

An information processing program for causing a processor of an information processing apparatus to execute a process comprising:
outputting projection apparatus candidates capable of projecting onto a range of a projection surface by being installed in an installation range of a projection apparatus based on designation of the range of the projection surface and the installation range of the projection apparatus received from a user based on an image captured by an imaging apparatus.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-049515) filed on Mar. 25, 2022, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a, 62: memory
6: projection object
10: projection apparatus
11: projection range
12: optical modulation unit
15: housing
21: light source
22: optical modulation portion
23: projection optical system
24: control circuit
31: second optical system
32, 122: reflective member
33: third optical system
34: lens
50: information processing apparatus
51: touch panel
61: processor
63: communication interface
64: user interface
65: sensor
69: bus
80: physical space image
81: floor
82: wall
91: first virtual projection surface
92: first installable range
93: second installable range
101: body part
102: first member
103: second member
104: projection direction changing mechanism
105: shift mechanism
106: optical unit
121: first optical system
151: first virtual projection apparatus
251: second virtual projection apparatus
252: second virtual projection surface
261: lens shift range
341: virtual projection surface
351: installation candidate range
361: compatible model list
371: installable range
381: crop mark
G1: image
P1 to P4: position
D1 to D3: projection distance

What is claimed is:

1. An information processing apparatus comprising a processor,
wherein the processor is configured to:
acquire first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
generate second image data representing a second image in which the first virtual projection surface, one of the first virtual projection apparatus or an installable range of the first virtual projection apparatus, and one of the second virtual projection apparatus or an installable range of the second virtual projection apparatus are displayed on the first image based on the first virtual projection surface data, the first virtual projection apparatus data, and the second virtual projection apparatus data; and
output the second image data to an output destination.

2. The information processing apparatus according to claim 1,
wherein the second image includes the first virtual projection surface, the installable range of the first virtual projection apparatus, and the installable range of the second virtual projection apparatus, and
the processor is configured to set the installable range of the first virtual projection apparatus and the installable range of the second virtual projection apparatus based on at least one of a position or a size of the first virtual projection surface.

3. The information processing apparatus according to claim 2,
wherein the processor is configured to reset the installable range of the first virtual projection apparatus and the installable range of the second virtual projection apparatus in a case
in which at least one of the position or the size of the first virtual projection surface is changed.

4. The information processing apparatus according to claim 1,
wherein the second image includes the first virtual projection surface, the first virtual projection apparatus, and the installable range of the second virtual projection apparatus, and
the processor is configured to:
set at least one of a position or a size of the first virtual projection surface based on a position of the first virtual projection apparatus; and
set the installable range of the second virtual projection apparatus based on at least one of the position or the size of the first virtual projection surface.

5. The information processing apparatus according to claim 4,
wherein the processor is configured to reset at least one of the position or the size of the first virtual projection surface and the installable range of the second virtual projection apparatus in a case in which the position or a parameter of the first virtual projection apparatus is changed.

6. The information processing apparatus according to claim 4,
wherein the processor is configured to reset the installable range of the second virtual projection apparatus in a case in which the position of the first virtual projection surface is changed.

7. The information processing apparatus according to claim 1,
wherein the second image includes the first virtual projection surface, the first virtual projection apparatus, the second virtual projection apparatus, and a second virtual projection surface corresponding to the second virtual projection apparatus, and
the processor is configured to set a position of the second virtual projection surface and a position of the second virtual projection apparatus based on a position of the first virtual projection apparatus and a position of the first virtual projection surface.

8. The information processing apparatus according to claim 7,
wherein the processor is configured to:
set a size of the first virtual projection surface based on the position of the first virtual projection apparatus and the position of the first virtual projection surface;
set the position of the second virtual projection apparatus based on the position of the first virtual projection apparatus; and
set a parameter of the second virtual projection surface related to the position and a size of the second virtual projection surface based on the position and the size of the first virtual projection surface.

9. The information processing apparatus according to claim 7,
wherein the processor is configured to:
set a size of the first virtual projection surface based on the position of the first virtual projection apparatus and the position of the first virtual projection surface;
set the position and a size of the second virtual projection surface based on the position and the size of the first virtual projection surface; and
set a parameter of the second virtual projection surface related to the position of the second virtual projection surface based on the position of the first virtual projection apparatus.

10. The information processing apparatus according to claim 7,
wherein the processor is configured to perform a process of including, in the second image, an image indicating a range in which at least one of the position of the first virtual projection surface or the position of the second virtual projection surface, or a size of the first virtual projection surface or a size of the second virtual projection surface is adjustable by changing a parameter of the first virtual projection apparatus or the second virtual projection apparatus.

11. The information processing apparatus according to claim 7,
wherein the processor is configured to reset at least one of an installation state of the second virtual projection apparatus, a parameter of the second virtual projection apparatus, or the position of the second virtual projection surface in a case in which an installation state of the first virtual projection apparatus or the position of the second virtual projection apparatus is changed.

12. The information processing apparatus according to claim 7,
wherein the processor is configured to switch between a state of performing a setting of the second virtual projection apparatus and the second virtual projection surface according to a constraint based on a setting of the first virtual projection apparatus and the first virtual projection surface, and a state of performing the setting of the second virtual projection apparatus and the second virtual projection surface without the constraint.

13. The information processing apparatus according to claim 1,
wherein the processor is configured to output candidates of a projection apparatus capable of projecting onto a range of a projection surface by being installed in an installation range of the projection apparatus based on designation of the range of the projection surface and the installation range of the projection apparatus received from a user based on a third image captured by the imaging apparatus, and
the first virtual projection apparatus and the second virtual projection apparatus are virtual projection apparatuses indicating each projection apparatus selected by the user from among the candidates.

14. The information processing apparatus according to claim 13,
wherein the processor is configured to limit the installable range of at least one of the first virtual projection apparatus or the second virtual projection apparatus to a region overlapping with the installation range of the projection apparatus and display the region on the first image.

15. The information processing apparatus according to claim 13,
wherein the processor is configured to output the candidates of the projection apparatus together with a usage condition of the candidates of the projection apparatus.

16. The information processing apparatus according to claim 1,
wherein the processor is configured to perform control, in the second image, to make visibility of one lower than visibility of other among: the first virtual projection surface; the one of the first virtual projection apparatus or the installable range of the first virtual projection apparatus; and the one of the second virtual projection apparatus or the installable range of the second virtual projection apparatus.

17. An information processing method performed by a processor of an information processing apparatus, the method comprising:
acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
generating second image data representing a second image in which the first virtual projection surface, one of the first virtual projection apparatus or an installable range of the first virtual projection apparatus, and one of the second virtual projection apparatus or an installable range of the second virtual projection apparatus are displayed on the first image based on the first virtual projection surface data, the first virtual projection apparatus data, and the second virtual projection apparatus data; and
outputting the second image data to an output destination.

18. A non-transitory computer readable medium storing an information processing program for causing a processor of an information processing apparatus to execute a process comprising:
acquiring first image data representing a first image captured by an imaging apparatus, first virtual projection surface data related to a first virtual projection surface, first virtual projection apparatus data related to a first virtual projection apparatus corresponding to the first virtual projection surface, and second virtual projection apparatus data related to a second virtual projection apparatus;
generating second image data representing a second image in which the first virtual projection surface, one of the first virtual projection apparatus or an installable range of the first virtual projection apparatus, and one of the second virtual projection apparatus or an installable range of the second virtual projection apparatus are displayed on the first image based on the first virtual projection surface data, the first virtual projection apparatus data, and the second virtual projection apparatus data; and
outputting the second image data to an output destination.
